(19) United States
(12) Patent Application Publication
(10) Pub. No.: US 2022/0124995 A1
(43) Pub. Date: Apr. 28, 2022

(54) PLANT INCUBATION APPARATUSES AND RELATED METHODS

(71) Applicant: 1769474 ALBERTA LTD., Edmonton (CA)

(72) Inventors: Bryan Cunningham, Edmonton (CA); Ali Ghadyali, Edmonton (CA); Steven Fyke, Edmonton (CA); Trevor Dix, Edmonton (CA); Tyler Kibler, Edmonton (CA); Jason Griffin, Edmonton (CA)

(73) Assignee: 1769474 ALBERTA LTD., Edmonton (CA)

(21) Appl. No.: 17/422,122

(22) PCT Filed: Jan. 10, 2020
(86) PCT No.: PCT/CA2020/050028

§ 371 Date: Jul. 9, 2021

Related U.S. Application Data
(60) Provisional application No. 62/791,558, filed on Jan. 11, 2019.

(51) Int. Cl. A01G 31/02; A01G 9/029; A01G 9/24

(52) U.S. Cl. CPC A01G 31/02; A01G 9/029; A01G 2031/006; A01G 9/246; A01G 9/249

(57) ABSTRACT

Plant incubation apparatuses are provided. In some embodiments, the plant incubation apparatus may comprise a housing defining an upper chamber and a lower chamber; a partition positioned between the upper and lower chambers; and a plant-retaining opening extending through the partition that receives and supports a plant therein such that roots of the plant are positioned in the lower chamber and a remainder of the plant is positioned in the upper chamber. In some embodiments, the plant incubation apparatus may comprise at least one sensing device collecting data indicative of at least one of a plant property and an environmental parameter within the apparatus. Also provided are related methods.

### RELATED APPLICATION

The present application claims priority to U.S. Provisional Patent Application No. 62/791,558, filed Jan. 11, 2019, the entire contents of which are incorporated herein by reference.

### FIELD OF THE DISCLOSURE

The present disclosure relates to apparatuses for facilitating the growth and care of plants such as vegetables and herbs. More particularly, the present disclosure relates to hydroponic apparatuses for plants.

### BACKGROUND

Traditional plant growing methods and systems include cultivating soil and growing various plants in the soil. Such growing may take place outdoors (e.g. gardens and fields) or indoors (e.g. indoor potted plants, greenhouses, etc.). Such methods provide limited control of various growth conditions.

In hydroponic plant growing apparatuses and systems, plants may typically be grown with their roots suspended in a solution (e.g. water mixed with minerals and/or chemicals) rather than planted in soil. Growing conditions may be controlled and/or monitored according to various considerations such as the type of plant, desired growth rate, plant health, etc. Growing conditions that may be controlled and/or monitored include, but are not limited to, light, temperature, solution pH, solution composition, etc. Such apparatuses and systems may be used for growing various plants such as vegetables and/or herbs.

Existing plant growing apparatuses and systems may be limited in their ability to provide intelligent or dynamic monitoring of the plant growing environment, plant conditions, etc. Existing plant growing apparatuses and systems may also be limited in their ability to provide customizable and controlled environments for individual plants or groups of plants.

### SUMMARY

In one aspect, there is provided a plant incubation apparatus comprising: a housing defining an upper chamber and a lower chamber, the lower chamber disposed below the upper chamber; a partition positioned between the upper and lower chambers; a plant-retaining opening extending through the partition that receives and supports a plant therein such that roots of the plant are positioned in the lower chamber and a remainder of the plant is positioned in the upper chamber.

In some embodiments, the partition substantially environmentally isolates the upper chamber from the lower chamber.

In some embodiments, the apparatus further comprises at least one first door for accessing the upper chamber and at least one second door for accessing the lower chamber.

In some embodiments, the apparatus further comprises a first control mechanism operatively connected to the upper chamber and operable to control a first environmental parameter of the upper chamber.

In some embodiments, the apparatus further comprises a second control mechanism operatively connected to the lower chamber and operable to control a second environmental parameter of the lower chamber.

In some embodiments, the first control mechanism comprises a first temperature control mechanism, the first temperature control mechanism operable to control the temperature of the upper chamber.

In some embodiments, the second control mechanism comprises a second temperature control mechanism, the second control mechanism operable to control the temperature of the lower chamber.

In some embodiments, the apparatus further comprises at least one sensing device that measures at least one of the first and second environmental parameters.

In some embodiments, the apparatus further comprises a control module operatively connected to the at least one sensing device and operable to control at least one of the first and second environmental parameters in response to output from the at least one sensing device.

In some embodiments, the apparatus further comprises a water solution circulation system that supplies a water solution to the roots of the plant.

In some embodiments, the water solution circulation system comprises a first reservoir and a second reservoir, wherein the roots of the plant are at least partially suspended in the first reservoir and the second reservoir supplies the water solution to the first reservoir.

In some embodiments, the second reservoir is in fluid communication with a water source and at least one chemical source such that the water and the at least one chemical are combined in the second reservoir.

In some embodiments, the housing comprises an outer housing and an inner housing, the inner housing defining at least a portion of the upper chamber and lower chamber.

In some embodiments, at least one airflow passage is defined between the outer housing and the inner housing, the airflow passage fluidly connecting at least one of the first and second inner chambers with the external environment.

In some embodiments, the apparatus further comprises at least one selectively controllable damper positioned in the at least one airflow passage and operable to control airflow through the at least one airflow passage.

In another aspect, there is provided a method for growing at least one plant in a plant incubation apparatus comprising an upper chamber and a lower chamber, the method comprising: introducing the at least one plant into the plant incubation apparatus such that roots of the at least one plant are positioned in the lower chamber and a remainder of the at least one plant is positioned in the upper chamber; and incubating the at least one plant in the plant incubation apparatus.

In some embodiments, the method further comprises adjusting the at least one environmental parameter of one of the upper chamber and the lower chamber independently from the other one of the upper and lower chamber.

In another aspect, there is provided a plant incubation apparatus comprising: at least one inner chamber for growing at least one plant; and at least one sensing device operatively connected to the inner chamber, the at least one sensing device collecting data indicative of at least one of a plant property and an environmental parameter within the at least one inner chamber.

In some embodiments, the at least one sensing device comprises a camera, and the data comprises at least one image taken by the camera.

In some embodiments, the apparatus further comprises at least one processor that processes the data to diagnose a plant condition.

In some embodiments, the at least one processor automatically adjusts at least one operational setting of the apparatus as a function of the data.

In some embodiments, the at least one processor generates output as a function of the data.

In some embodiments, the output is a notification for a user.

In another aspect, there is provided a method at a plant incubation apparatus comprising at least one sensing device, the method comprising: collecting data via the at least one sensing device, the data indicating at least one of a plant property and an environmental parameter within the plant incubation apparatus; adjusting at least one operational setting of the apparatus as a function of the data.

In some embodiments, transmitting the data to a remote device and receiving a control signal from the remote device, the control signal indicating the at least one operational setting to be adjusted.

In some embodiments, the data indicating the at least one plant property is processed to diagnose a plant condition.

In some embodiments, the method further comprises generating a notification for a user as a function of the data.

Other aspects and features of the present disclosure will become apparent, to those ordinarily skilled in the art, upon review of the following description of the specific embodiments of the disclosure.

### BRIEF DESCRIPTION OF THE DRAWINGS

The present disclosure will be better understood having regard to the drawings in which:

FIGS. 1A to 1D are perspective, front, side, and rear views, respectively, of an example plant incubation apparatus according to some embodiments;

FIG. 2 is a front perspective view of the apparatus of FIGS. 1A to 1D, with the doors removed and a plant received in an upper chamber;

FIG. 3 is a perspective view of the apparatus of FIGS. 1A to 1D, with the doors removed and without a plant in the upper chamber;

FIG. 4 is a front view of the apparatus of FIGS. 1A to 1D, with the doors removed and without a plant in the upper chamber;

FIG. 5 is a schematic view of another example plant incubation apparatus, according to some embodiments;

FIG. 6 is an enlarged schematic view of a plant-containing vessel of the apparatus of FIG. 5;

FIG. 7 is a schematic view of a plant incubation apparatus having a single-reservoir design, according to some embodiments;

FIG. 8 is a schematic view of a plant incubation apparatus having a two-reservoir design, according to some embodiments;

FIG. 9 is a schematic view of a plant incubation apparatus having a three-reservoir design, according to some embodiments;

FIG. 10 is a perspective view of another example plant incubation apparatus, according to some embodiments;

FIG. 11 is a perspective view of an inner housing of the apparatus of FIG. 10;

FIG. 12 is a perspective view of an internal wall of the apparatus of FIG. 10;

FIGS. 13A to 13E are cross-sectional perspective views of the apparatus of FIG. 10.

FIG. 14 is a perspective view of the apparatus of FIG. 10 with an example door system, according to some embodiments;

FIG. 15A is a front perspective view of the door system of FIG. 14;

FIG. 15B is a rear perspective view of the door system of FIG. 14;

FIG. 15C is a front and enlarged, partial view of the door system of FIGS. 15A and 15B, but further showing a display panel;

FIG. 16 is a flowchart of an example method for growing at least one plant in a plant incubation apparatus, according to some embodiments;

FIG. 17 is a flowchart of another example method, according to some embodiments;

FIG. 18 is a functional block diagram of another example plant incubation apparatus, according to some embodiments;

FIG. 19 illustrates an example method of imaging a plant;

FIG. 20 a partial interior view of a plant incubation apparatus, according to some embodiments, showing example proximity sensors;

FIG. 21 illustrates an example current plant size and plant size trajectory;

FIG. 22 illustrates an example method of alerting a user of a diagnosed plant condition;

FIG. 23 is a flowchart of an example method at the plant incubation apparatus of FIG. 18, according to some embodiments;

FIG. 24 is a flowchart of another example method, according to some embodiments;

FIGS. 25A to 25H are screenshots of various screens of a mobile application, according to some embodiments;

FIG. 26 is a perspective view of an example multi-plant incubation apparatus, according to some embodiments; and

FIGS. 27 is a perspective view of the apparatus of FIG. 26, shown with a door system.

### DETAILED DESCRIPTION

According to some aspects of the disclosure, there is provided a plant incubation apparatus. The apparatus may also be referred to as a “grow box” herein. The apparatus may be used for incubating a plant such as a vegetable, fruit, or herb (although embodiments are not limited to a particular plant type). As used herein, the terms “incubating” and “growing” may each refer to maintaining a plant under desired conditions for any suitable period of time. The example apparatuses shown in the drawings and described herein are hydroponic. However, embodiments are not limited to hydroponic apparatuses. For example, a grow box may contain soil for providing nutrients to plant roots, rather than a solution. Alternatively, the grow box may be aeroponic.

According to an aspect, the plant incubation apparatus provides a closed environment for incubating the plant. Feedback about the plant, status of the apparatus, and/or environmental parameters within the apparatus may be used to dynamically and automatically adjust the apparatus to provide improved or optimized growing conditions. Feedback data may also be logged and stored in a database to generate historical growing data.

The closed environment may provide the ability to have two or more distinct zones or spaces within the apparatus for different parts of the plant. For example, one zone may be a “growing zone” for the plant stem and the canopy (i.e. “above ground” parts) and another zone may be a “root zone” for the roots of the plant. The environment of each zone may be individually customized. For example, the growing zone may be kept warmer than the root zone.

The closed environment with feedback may also allow for easier and more accurate monitoring of the plant(s). Data about the plant(s) may be collected and processed. One or more potential plant conditions may be diagnosed based on the collected data. The apparatus may also initiate one or more treatment actions, alert a user to the plant condition, and/or make a recommendation for the one or more actions to be taken.

As used herein, the terms “top” and “bottom”, “upper” and “lower”, “upward” and “downward” and the like refer to the typical orientation of a plant incubation apparatus; however, a person skilled in the art will recognize that these are relative terms that are used for ease of description only and do not limit the orientation of the apparatuses described herein.

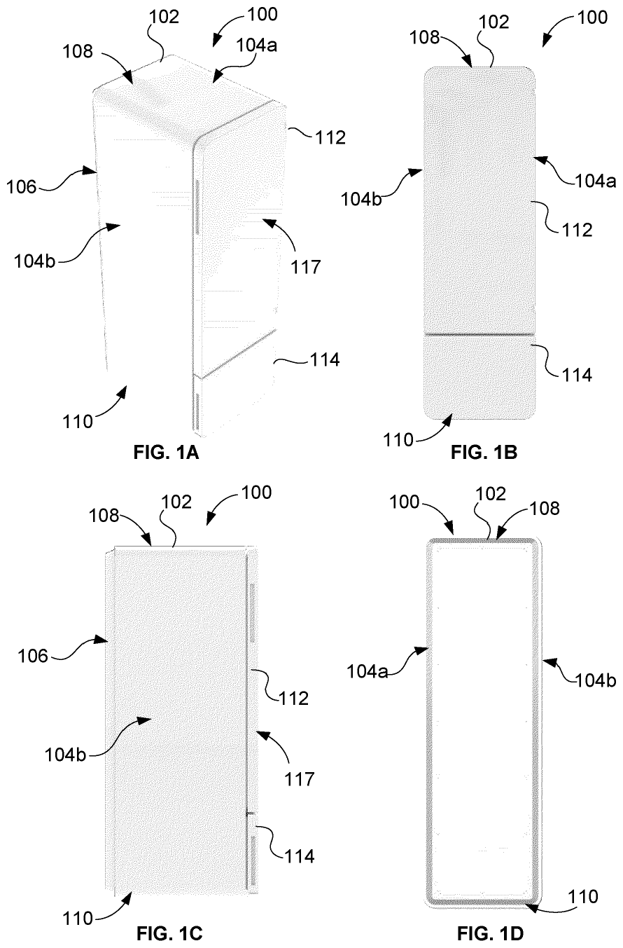

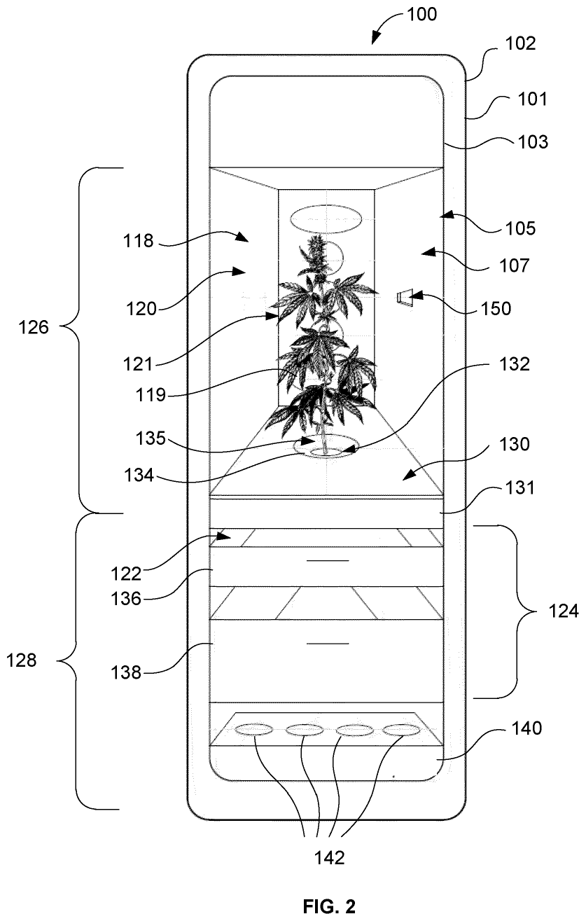

An example plant incubation apparatus 100 will be discussed with reference to FIGS. 1A to 4. As shown in FIGS. 1A-1D, the apparatus 100 may comprise a housing 102 forming sides 104a and 104b, rear 106, top 108 and bottom 110 of the apparatus 100. The apparatus 100 may further comprise an upper door 112 and a lower door 114 disposed at the front 117 of the apparatus 100. The housing 102 may comprise at least one inner chamber 118 (shown in FIG. 2) for growing one or more plants. The doors 112 and 114 and the housing 102 may enclose the at least one inner chamber 118 when the doors 112 and 114 are closed, thereby providing a closed environment for growing the plant(s).

FIGS. 2 to 4 show the apparatus 100 with the doors 112 and 114 removed such that the at least one inner chamber 118 is visible. An example plant 119 is shown in FIG. 2 being incubated in the apparatus 100.

In this embodiment, the housing 102 comprises an outer housing 101 and an inner housing 103. The inner housing 103 may have an outer face 105 and an inner face 107. The inner face 107 may at least partially define the at least one inner chamber 118 therein.

In this embodiment, the at least one inner chamber 118 of the apparatus 100 includes a first inner chamber 120 and a second inner chamber 122 below the first inner chamber 120. Herein, the first inner chamber 120 will also be referred to as an “upper chamber” 120 and the second inner chamber 122 will be referred to as a “lower chamber” 122.

The upper chamber 120 and the lower chamber 122 may be at least partially separated by a partition 130. In this embodiment, the partition 130 comprises a shelf or panel 131 disposed (e.g. mounted) within the inner housing 103. In some embodiments, the panel 131 may extend substantially completely across the interior of the inner housing 103. In some embodiments, the panel 131 may be substantially flush with the inner face 107 of the inner housing 103. The partition 130 may thereby substantially segregate the upper chamber 120 from the lower chamber 122.

A plant-retaining opening 132 may extend through the partition 130 to retain at least one plant therein. The plant-retaining opening 132 may be configured to receive and support the plant 119 and/or a plant-containing vessel (not shown) containing the plant 119 therein. In this embodiment, the plant-retaining opening 132 is defined by an inner wall 134 of the panel 131. In some embodiments, the inner wall 134 may comprise an annular shelf portion 135 to support the plant-containing vessel thereon.

The plant 119 may be received through the opening 134 such that a lower portion of the plant 119 (not shown) is disposed in the lower chamber 122 and an upper portion 121 of the plant 119 is disposed in the upper chamber 120. The lower portion of the plant 119 may comprise the roots and the upper portion 121 may comprise the remainder of the plant 119, including stem(s), leaves, etc. In some embodiments, one or more light sources (not shown) may be disposed in the upper chamber 120 to provide light to the upper portion 121 of the plant 119. The upper chamber 120 may thereby generally define a “growing zone” 126 and the lower chamber 122 may generally define a “root zone” 128.

In this example, the apparatus 100 is hydroponic. The apparatus 100 may further comprise a reservoir region 124 having one or more fluid reservoirs therein. One or more of the fluid reservoirs may contain a water solution therein for supporting plant growth. In this embodiment, the reservoir region 124 is within the lower chamber 122 and a first fluid reservoir 136 and a second fluid reservoir 138 are provided in the reservoir region 124.

In some embodiments, the roots of the plant 119 may be at least partially suspended in the water solution in one of the fluid reservoirs. In this embodiment, the roots of the plant 119 are at least partially suspended in the first fluid reservoir 136.

The second reservoir 138 may be in fluid communication with the first reservoir 136 such that the second reservoir 138 may supply the water solution for the first reservoir 136. The second reservoir 138 may thereby function as a “mix reservoir” to prepare the water solution and the first reservoir 136 may function as a “plant reservoir” to supply the roots of the plant 119 with the water solution

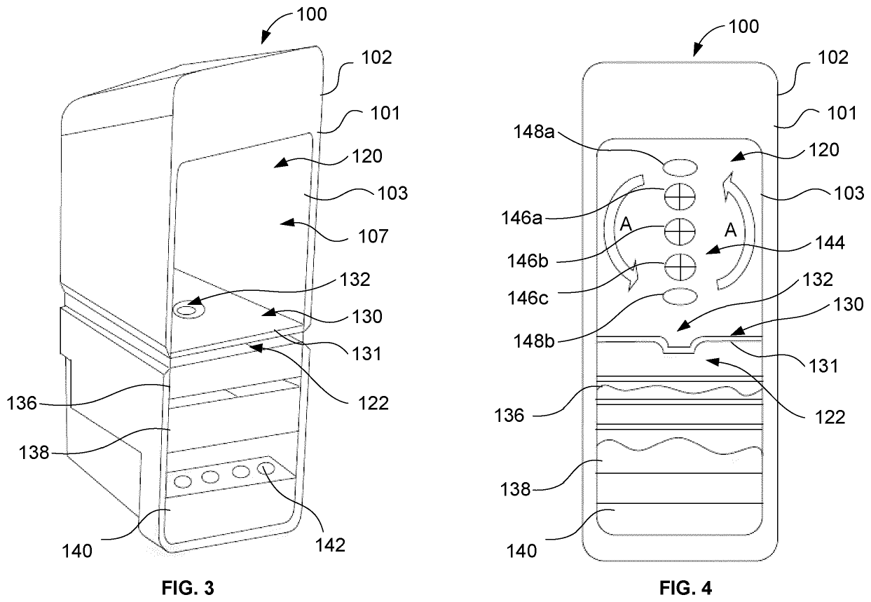

In some embodiments, the second reservoir 138 may receive water from a water source (not shown) and at least one chemical from at least one chemical source (not shown) such that the water and chemical(s) mix together within the second reservoir 138. The at least one chemical may comprise a nutrient or mixture of nutrients, a pH controlling chemical (e.g. acid or base), or any other chemical suitable for preparation of the water solution to support growth of the plant 119. As shown in FIGS. 2 and 3, a storage platform 140 with four slots 142 may be provided to receive four respective chemical containers thereon (not shown). In this embodiment, the platform 140 is disposed within the lower chamber 122. In other embodiments, the platform 140 may be disposed within a separate storage chamber (not shown).

In some embodiments, the second reservoir 138 may be fluidly connected to the water source and/or the at least one chemical source. In other embodiments, a user may manually add water and/or chemical(s) to the second reservoir 138 as required.

The water solution, as prepared and maintained in the second reservoir 138, may be transported from the second reservoir 138 to the first reservoir 136 by any suitable means. In some embodiments, first and second reservoirs 136 and 138 may be included in a fluid circulation system (not shown), as described in more detail below.

Closed Environment Control

As shown in FIGS. 2 to 4, the interior of the apparatus 100 may include a growing zone 126 and a root zone 128, which are substantially segregated by the partition 130.

In some embodiments, the root zone 128 may be at least partially insulated from the growing zone 126 and vice versa. In some embodiments, the root zone 128 and the growing zone 136 are substantially environmentally isolated from one another by the partition 130. As used herein, “environmentally isolated”, may refer to a zone having relatively independent environmental parameters (e.g. temperature, humidity, CO2 levels, etc.) that are not substantially affected by the environmental parameters of the other zone (although minor influences of one zone on the other may still be possible). In some embodiments, at least one of the upper chamber 120 and lower chamber 122 may comprise an additional insulation layer (not shown) to facilitate environmental isolation of the growing zone 126 and root zone 128. Substantially environmentally isolating the roots from the remainder of the plant 119 may mimic (at least partially) the way in which a plant grows naturally in soil.

In some embodiments, environmental parameters of the growing zone 126 and root zone 128 may be independently monitored and/or controlled. As used herein, “independently controlled” or “independently controllable” refer to controlling the environmental parameter in one zone without substantially affecting the same environmental parameter in the other zone (although minor influences of one zone on the other are still possible). Independent environmental control mechanisms may be provided for each of the growing and root zones 126 and 128. For example, independent temperature control mechanisms may allow the temperature in each of the growing zone 126 and the root zone 128 to be independently and selectively controlled. In this manner, the root zone 128 may be kept cooler than the growing zone 126 to at least partially mimic the way a plant grows naturally.

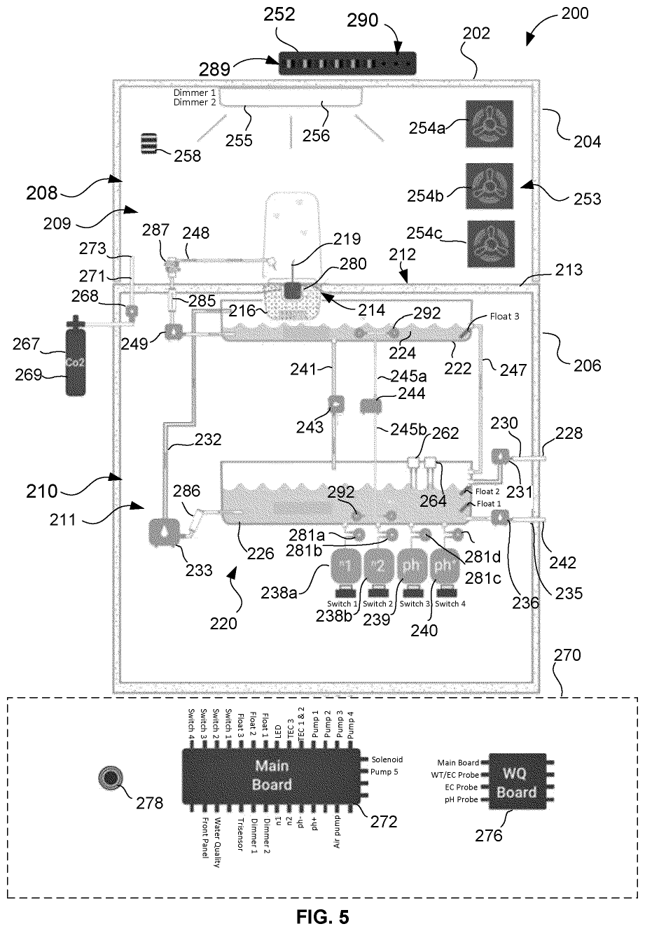

As shown in FIG. 4, the apparatus 100 may comprise a first temperature control mechanism 144 operatively connected to the upper chamber 120 and operable to control the temperature of the upper chamber 120. In this embodiment, the first temperature control mechanism 144 is disposed in a rear airflow passage (not shown) between the outer housing 101 and inner housing 103, as described in more detail below. In other embodiments, the first temperature control mechanism 114 may be disposed within the upper chamber 120. Note that in FIG. 4, the inner housing 103 is shown as transparent for illustrative purposes such that the first temperature control mechanism 144 is visible.

In some embodiments, the first temperature control mechanism 144 may comprise at least one Thermoelectric Control (TEC) module. TEC modules are also known as Peltier modules or devices, thermoelectric modules (TEMs), and thermoelectric coolers (TECs). TEC modules employ a phenomenon known as the “Peltier Effect” to provide heating and cooling. In this embodiment, the first temperature control mechanism 144 comprises three TEC modules 146a, 146b, and 146c. However, embodiments are not limited to use of TEC modules or to the specific number and arrangement of TEC modules described herein.

In some embodiments, at least one airflow opening may extend through the inner housing 103 to fluidly connect the upper chamber 120 with the rear airflow passage. In this embodiment, an upper airflow opening 148a is provided above the TEC modules 146a, 146b, and 146c and a lower airflow opening 148b is provided below the TEC modules 146a, 146b, and 146c. As air flows between the upper chamber 120 and the rear airflow passage, it may contact the TEC modules 146a, 146b, and 146c, thereby maintaining the air temperature as dictated by the TEC modules 146a, 146b, and 146c.

Optionally, a second temperature control mechanism (not shown in FIG. 4) may be operatively connected to the lower chamber 122 and may be operable to control the temperature of the lower chamber 122. In some embodiments, the second temperature control may comprise at least one TEC module. In some embodiments, the second temperature control mechanism may control the temperature of the water solution in at least one of the first reservoir 136 and the second reservoir 138. Therefore, in some embodiments, the temperature of the water solution feeding the roots of the plant 119 may be independently controlled and may not be substantially affected by the influence from the warmer growing zone 126.

Independent control of the growing and/or root zones 126 and 128 may improve the health of the plant 119 and may further resolve various issues of conventional growing systems. For example, independent zone control may prevent the water solution in the fluid reservoirs 136, 138 from getting too hot due to temperature conduction from the growing zone 126. Independent zone control may also allow cooler water to be added to the fluid reservoirs 136, 138 without reducing the temperature in the growing zone 126.

In some embodiments, the apparatus 100 may comprise at least one sensing device 150 (shown in FIG. 2) for monitoring at least one environmental parameter in the growing zone 126 and/or root zone 128. Non-limiting examples of suitable sensing devices include at least one of a temperature sensor, a humidity sensor, a CO2 sensor, a pH sensor, and an electrical conductivity sensor, as will be described in more detail below.

Therefore, the apparatus 100 may provide a closed environment with greater plant monitoring, analysis, and/or environmental control than conventional plant growing systems. Various aspects of example monitoring, analysis, and environmental control will be described in more detail below. However, it is to be understood that the monitoring, analysis, and environmental control features described below are not limited to the specific structure of the apparatus 100 and such features may be implemented in various other apparatuses for facilitating plant growth.

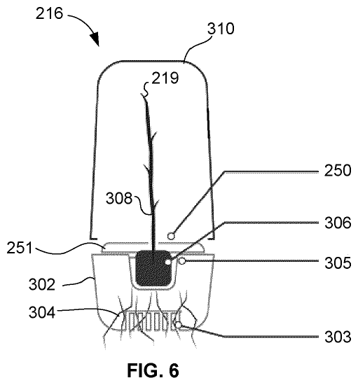

FIG. 5 is a schematic view of a plant incubation apparatus 200 according to some embodiments. The apparatus 200 may include a housing 202 comprising an upper housing portion 204 and a lower housing portion 206. The upper housing portion 204 may be mounted on the lower housing portion 206.

Similar to the apparatus 100 in FIGS. 1A to 4, the apparatus 200 may define an upper, growing zone 208 and a lower, root zone 210. The upper housing portion 204 may define an upper chamber 209 and the lower housing portion 206 may define a lower chamber 211. The growing zone 208 may generally be located within the upper chamber 209, and the root zone 210 may generally be located within the lower chamber 211.

The apparatus 200 may also include one or more doors (not shown). In some embodiments, the apparatus 200 may include upper and lower doors (similar to upper and lower doors 112 and 114 in FIGS. 1A to 10) to provide separate access to the growing zone 208 and the root zone 210.

A partition 212 may at least partially segregate the upper chamber 209 from the lower chamber 211 thereby at least partially segregating the growing zone 208 and the root zone 210. In this example, the partition 212 comprises an upper panel 213 of the lower housing portion 206. In other embodiments, the upper and lower housing portions 204 and 206 may be formed as a unitary body and a separate panel or other type of insulating layer may be mounted between the upper and lower housing portions 204 and 206.

A plant-retaining opening 214 may extend through the partition 212. In this embodiment, the plant-retaining opening 214 extends through the upper panel 213 and is configured to receive a plant-containing vessel 216 (e.g. a planting pod) therethrough. The plant-containing vessel 216 may contain a plant 219 therein. When the plant-containing vessel 216 is received in the plant-retaining opening 214, the roots (not shown in FIG. 5) of the plant 219 may be positioned in the root zone 210 and the remainder of the plant 219 may extend upward into the growing zone 208 through the plant-retaining opening 214.

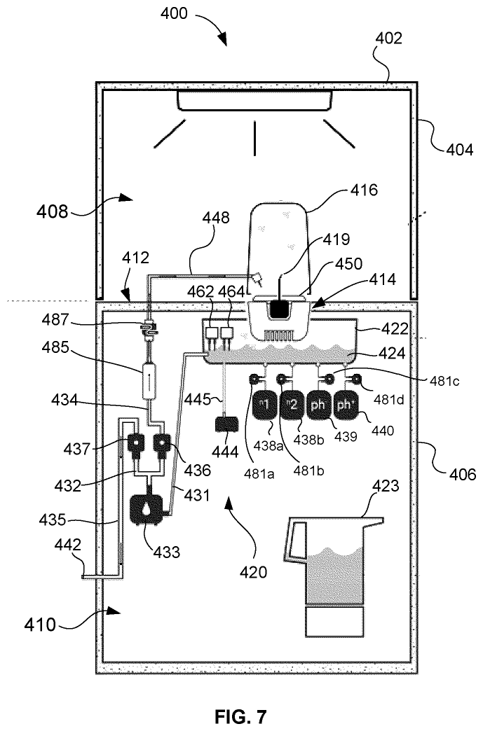

FIG. 6 is an enlarged schematic view of the plant-containing vessel 216 of the apparatus 200 of FIG. 5. The plant-containing vessel 216 is shown only by way of example, and embodiments are not limited to the inclusion of plant-containing vessels or the particular vessel 216 shown in FIG. 6.

The plant-containing vessel 216 in this embodiment may include a lower receptacle 302 (e.g. a basket) that supports the roots 304 of the plant 219. In some embodiments, the receptacle 302 may contain a portion of soil or any other suitable plant growth medium. In some embodiments, the receptacle 302 may have perforations 303 or other openings therethrough. The roots 304 of the plant 219 may grow downwards and outwards beyond the receptacle 302, through the perforations 303, as shown in FIG. 6.

In some embodiments, the receptacle 302 may define an upwardly disposed cavity 305 configured to receive at least one plant support material therein. In this embodiment, the cavity 305 is configured to receive a piece (e.g. cube) of rockwool 306 therein. The rockwool 306 may provide support for a stem 308 of the plant 219. In some embodiments, the rockwool 306 may be at least partially surrounded by an absorbent such as hydroton (not shown).

In some embodiments, a watering mechanism 250 may be disposed proximate the plant 219. The watering mechanism 250 may function to irrigate the plant 219. As used herein, “irritate” or ‘irrigation” may refer to providing water directly or in close proximity to a plant. In this embodiment, the watering mechanism 250 comprises a drip ring 251 disposed around the stem 308 of the plant 219 and above the rockwool 306.

Optionally, a removable cover 310 may be positioned above the lower receptacle 302 to enclose the stem 308 of the plant 219 therein. The cover 310 may also be referred to as a “humidity dome” and may help maintain humidity in the area directly around the plant 219. The cover 310 may be particularly beneficial for germinating seeds and/or for protecting young plants (e.g. seedlings).

In some embodiments, the plant-containing vessel 216 may be removable to allow easy swapping and/or inspection of the plant 219 held within. As the plant 219 matures past a certain size or age, the vessel 216 may be replaced with another suitable vessel for containing the mature plant or the plant 219 may be grown without such a vessel.

The growing zone 208 may include at least one light source 255. In this embodiment, the light source 255 comprises an LED (light emitting diode) module 256. However, embodiments are not limited to LED light sources and any suitable light sources may be used. In some embodiments, at least one dimmer mechanism may be operatively connected to the LED module 256 and may be controllable to control the output level(s) of the LED module. In this embodiment, two dimmer mechanisms, Dimmer 1 and Dimmer 2, are operatively connected to the LED module 256. In some embodiments, auxiliary lights (not shown) may be provided at various heights within the upper chamber 209 and such auxiliary lights may be independently controllable to direct light to various parts of the plant.

In some embodiments, the growing zone 208 may be in fluid communication with a CO2 (carbon dioxide) source 267 to provide CO2 to the plant 219 for photosynthesis. In this embodiment, the CO2 source 267 comprises a CO2 tank 269 external to the housing 202. In other embodiments, the CO2 tank 269 may be disposed within the housing 202, for example, within the root zone 210 or within a separate storage chamber (not shown). A gas line 271 may extend from the tank 269, though the housing 202, to a gas outlet 273 within the growing zone 208. In some embodiments, a valve 268 may be in fluid communication with the gas line 271 and may be controllable to control the flow of CO2 therethrough. The valve 268 may be a solenoid valve or any other suitable type of valve.

In some embodiments, the growing zone 208 may further comprise one or more fans (not shown) to circulate air within the growing zone 208. The apparatus 200 may also include one or more vents or air passages (not shown) for circulating air through the growing zone 208. In some embodiments, one or more of the vents or air passages may be controllable to control the circulation of air within the growing zone 208, as will be described in more detail below.

In some embodiments, the apparatus 200 may further comprise a fluid circulation system 220. FIG. 5 shows one possible configuration of the fluid circulation system 220, although embodiments are not limited to the particular fluid circulation system 220 shown in FIG. 5. The fluid circulation system 220 in this embodiment is substantially (but not completely) located within the root zone 210.

The fluid circulation system 220 may include a plant reservoir 222 and a mix reservoir 226. The plant reservoir 222 and/or mix reservoir 226 may be removable and replaceable. Embodiments are not limited to circulation systems including two reservoirs. For example, the mix reservoir 226 may be omitted in some embodiments and the fluid circulation system 220 may be modified to use only the plant reservoir 222.

The plant reservoir 222 may be at least partially filled with a water solution 224. The roots of the plant 219 may be at least partially suspended in the water solution 224 in normal operation. The mix reservoir 226 may receive water and one or more nutrients or other chemicals to mix therein and form the water solution 224.

In some embodiments, the mix reservoir 226 may be fluidly connected to a water source (not shown). In some embodiments, the water source is a plumbed water source such as a local or regional water supply network. Alternatively, water may be manually added to the mix reservoir 226 by the user.

In this embodiment, water may be received into the mix reservoir 226 from the water source via an inlet 228 located external to the housing 202 and an inlet line 230 that connects the inlet 228 to the mix reservoir 226. A first water pump 231 may be activated and controlled to provide the desired amount of water from the inlet line 230 to the mix reservoir 226.

The mix reservoir 226 may be in fluid communication with at least one chemical source. The chemical source may comprise at least one nutrient source, pH controlling chemical source, and/or any other suitable chemical source for forming the water solution 224. In this example, the mix reservoir 226 is in fluid communication with first and second nutrient containers 238a and 238b, storing plant nutrients n1 and n2 therein, respectively. Pumps 281a and 281b may be activated and controlled to provide desired amounts of nutrients n1 and n2 to the mix reservoir 226 from the first and second nutrient containers 238a and 238b. The mix reservoir 226 may also be in fluid communication with first and second chemical containers 239 and 240, storing pH controlling chemicals pH− and pH+ therein, respectively. Pumps 281c and 281d may be activated and controlled to provide desired amounts of pH controlling chemicals pH− and pH+ to the mix reservoir 226 from the first and second chemical containers 239 and 240. In some embodiments, pumps 281a to 281d are peristaltic pumps. In other embodiments, pumps 281a to 281d are any other suitable type of pump.

In some embodiments, the first and second nutrient containers 238a and 238b and the first and second chemical containers 239 and 240 may be received in respective compartments (not shown) or in respective slots in a platform similar to the slots 142 in the platform 140 shown in FIG. 2. In some embodiments, switches (switch1, switch2, switch3, switch4) may be used as an input for sensing whether the containers 238a, 238b, 239 and 240 are secured in their respective compartments or slots. The switches (switch1 to switch4) may, for example, comprise push button switches, and may provide validation for the containers 238a, 238b, 239, and 240 being secured in their respective compartments or slots before engaging pumps 281a to 281d.

The mixed water solution 224 from the mix reservoir 226 may flow to the plant reservoir 222 via line 232. A second water pump 233 may be activated and controlled to drive the flow of the water solution 224 through line 232 to the plant reservoir 222. Optionally, one or more valves (not shown) may be in fluid communication with line 232 to control the flow of the water solution 224 therethrough. In some embodiments, a water filter 286 may be provided along line 232 to filter the water solution 224 before it enters the second water pump 233. The water filter 286 may be a ceramic water filter or any other suitable type of filter. In some embodiments, excess water solution 224 in the plant reservoir 222 may be returned to the mix reservoir 226 via an overflow line 247.

When it is desired to partially or fully drain the water solution 224 from the plant reservoir 222, the water solution 224 may flow from the plant reservoir 222 to the mix reservoir 226 via a first drain line 241. In some embodiments, a third water pump 243 may be activated and controlled to drive the flow of the water solution 224 from the plant reservoir 222 to the mix reservoir 226.

When it is desired to partially or fully drain the water solution 224 from the mix reservoir 226 and/or from the fluid circulation system 220 as a whole, the water solution 224 may flow from the mix reservoir 226 to an outlet 242 via a second drain line 235. In some embodiments, a fourth water pump 236 may be activated and controlled to drive the flow of the water solution 224 from the mix reservoir 226 to the outlet 242.

In some embodiments, the fluid circulation system 220 may also include a watering line 248. The watering line 248 may extend from the root zone 210 upward through the partition 212 into the growing zone 208 to supply the watering mechanism 250 (shown in FIG. 6). In this embodiment, the watering line 248 extends from the plant reservoir 222 to supply the drip ring 251. In other embodiments, the watering line 248 may extend directly from the mix reservoir 226 to supply the drip ring 251. The flow of the water solution 224 through the watering line 248 may be driven by a fifth water pump 249.

In some embodiments, a water filter 285 may be included on the watering line 248 to filter the water solution 224 prior to the water solution 224 entering the drip ring 251. In some embodiments, a UV filter 287 may also be included on the watering line 248 to kill micro-organisms in the water solution 224 before it reaches the plant 219. The UV filter 287 may allow for the water solution 224 to be recycled less often thus extending the interval between changing water in the fluid circulation system 220.

In some embodiments, at least one gas may be introduced into the fluid circulation system 220. In some embodiments, the gas comprises air. In this example, air bubbles may be introduced into the plant reservoir 222 and the mix reservoir 226 by an air pump 244 via gas lines 245a and 245b. In this embodiment, aerators 292 (e.g. air stones) bubble the air into the water solution 224 within the plant and mix reservoirs 222 and 226. The aerators 292 may serve two functions while bubbling: (1) creating oxygen-rich water so the roots of the plant 219 can receive oxygen while submerged; and (2) keeping the water solution 224 moving so it does not become stagnant. The air pump 244 may thereby provide aeration and water mixing for both the plant and mix reservoirs 222 and 226. In other embodiments, air may be introduced into the plant and/or mix reservoirs 222 and 226 by any suitable means.

The apparatus 200 optionally includes at least one control mechanism for controlling at least one environmental parameter of the growing zone 208 and/or the root zone 210. Several examples of control mechanisms will now be described.

In some embodiments, a first temperature control mechanism 253 may be operatively connected to the upper chamber 209. In this example, the first temperature control mechanism 253 comprises a first, second, and third TEC module 254a, 254b, and 254c. Optionally, a second temperature control mechanism (not shown) may be operatively connected to the lower chamber 211. In some embodiments, the second temperature control mechanism comprises a fourth TEC module (not shown). In some embodiments, the first temperature control mechanism 253, and optionally the second temperature control mechanism, may maintain a desired temperature difference between the growing and root zones (e.g. 10 to 15 degrees F.).

In some embodiments, the growing zone 208 may be maintained at a higher temperature than the root zone 210. In this example with the particular plant 219, the growing zone 208 is maintained at approximately 80 degrees F. whereas the root zone 210 is maintained at approximately 70 degrees F. The specific temperatures may vary in other embodiments and may depend on the type, size, age and/or health of the plant(s) being grown as well as other factors.

In some embodiments, one or more of the vents or air passages may be controllable such that air inside the apparatus 200 may be recycled either periodically or on a continuous basis at a chosen rate. In some embodiments, the air inside the apparatus 200 may be recycled based on a pre-determined schedule.

In some embodiments, the solenoid valve 268 may be controllable to control the amount of CO2 introduced into the growing zone 208 from the CO2 tank 269.

In some embodiments, the LED module 256 in the growing zone 208 may be controllable to output light at desired output levels. One or more dimmer mechanisms (e.g. Dimmer 1 and Dimmer 2) may control the output level(s) of the LED module 256. In some embodiments, Dimmer 1 and Dimmer 2 may also be controllable to provide spectrum control for the LED module 256 e.g. red/blue channel spectrum control. Light levels may also be controlled based on time of day, pre-determined light level cycles, etc.

The content and pH of the water solution 224 in the fluid circulation system 220 may also be controlled. Pumps 281a to 281d may be controllable to control the amount of nutrients and pH controlling chemicals supplied by the first and second nutrient containers 238a and 238b and the first and second pH chemical containers 239 and 240 to the mix reservoir 226. The first water pump 231 may be controllable to control the amount of water supplied to the mix reservoir 226.

The amount of the water solution 224 received by the plant 219 may be controlled by controlling the second and fifth water pumps 233 and 249. The second water pump 233 may be used to control the amount of solution 224 supplied to the plant reservoir 222 and the fifth water pump 249 may be used to control the amount of solution 224 supplied to the drip ring 251.

The apparatus 200 optionally includes various monitoring mechanisms, such as sensing devices, for monitoring one or more environmental parameters. In some embodiments, the one or more of the control mechanisms described above may be responsive to output from one or more monitoring mechanisms. Several examples of monitoring mechanisms will now be described.

In some embodiments, the growing zone 208 may include at least one sensing device for at least one of temperature, humidity and CO2. As shown in FIG. 5, in this embodiment, the growing zone 208 includes a temperature, humidity, and CO2 tri-sensor 258. In some embodiments, a solenoid and cylinder type solution may be implemented in the tri-sensor 258. In other embodiments, the growing zone 208 may include individual sensors for temperature, humidity and/or CO2. Non-limiting examples of suitable sensors include a DHT22 type sensor for temperature and humidity and a T6713 type sensor for CO2.

In some embodiments, the first, second, and third TEC modules 254a, 254b, and 254c, may be operatively connected to the tri-sensor 258 and are responsive to output therefrom to control the temperature of the growing zone 208. In some embodiments, the first, second, and third TEC modules 254a, 254b, and 254c may also include one or more temperature sensors therein (not shown) and may be responsive to output from those sensors.

In some embodiments, the solenoid valve 268 may be operatively connected to the tri-sensor 258 and responsive to output therefrom to control the amount of CO2 being supplied to the growing zone 208 from the CO2 tank 267. Measurements by the tri-sensor 258 may be used to maintain CO2 levels continuously at a set point using the solenoid valve 268.

In some embodiments, the growing zone 208 may also include one or more light sensors (not shown). In some embodiments, the LED module 256 (including Dimmer 1 and Dimmer 2) may be responsive to output from the one or more light sensors to control light intensity and/or light spectrum.

In some embodiments, the root zone 210 may include an Electrical Conductivity (EC) and/or Total Dissolved Solids (TDS) probe 262 disposed at the mix reservoir 226 to measure conductivity of the water solution 224. The TDS/EC probe 262 may thereby measure water hardness and contaminants of the water solution 224. In some embodiments, the TDS/EC probe 262 may also include a temperature sensor to measure the temperature of the water solution 224. The temperature sensor may comprise an NTC (negative temperature coefficient) thermistor or any other suitable type of sensor.

In some embodiments, the optional fourth TEC module may be operatively connected to the temperature sensor of the TDS/EC probe 262 and responsive to output therefrom. In some embodiments, the fourth TEC module may also include one or more temperature sensors and may be responsive to output from the one or more sensors.

In some embodiments, the root zone 210 may also include a pH probe 264 disposed at the mix reservoir 226 to measure pH levels of the water solution 224. The pumps 281c and 281d may be operatively connected to the pH probe 264 and may be responsive to output therefrom to control the amounts of the pH+ and pH− chemicals being supplied to the mix reservoir 226. In some embodiments, the pH probe 264 may be used as an input for automatic pH balancing. For example, pH balancing may be maintained based on a set point and readings from the pH probe 264.

In some embodiments, the fluid circulation system 220 may include one or more water level sensors. Example water level sensors on the plant reservoir 222 and mix reservoir 226 are also shown in FIG. 5. The water level sensors are float switches (Float 1, Float 2 and Float 3) in this embodiment (e.g. Float Switch 725-1128-ND type switches). In other embodiments, any other suitable type of water level sensors may be used. In some embodiments, the readings from the water level sensors may be used to provide notifications when the water levels in the plant reservoir 222 and/or mix reservoir 226 are too high or too low. In some embodiments, the readings may be used as input to autofill the mix reservoir 226 when the apparatus 200 is operated in a “plumbed mode” as described below.

In this example, two float switches (Float 1 and Float 2) are deployed in the mix reservoir 216 for reading of low and high-water levels respectively. A third float switch (Float 3) may be deployed in the plant reservoir 222. In some embodiments, the first and fourth water pumps 231 and 236 may be operatively connected to the Float 1 and Float 2 and responsive to output therefrom to adjust the amount of water being supplied to the mix reservoir 226 (via the first water pump 231) or the amount of water solution 224 being drained from the mix reservoir 226 (via the fourth water pump 236). For example, the water solution 224 may be drained from the mix reservoir 226 when the water level is too high to prevent flooding of the fluid circulation system 220. Output from Float 1 and Float 3 may also be used to ensure that the second and fifth water pumps 233 and 249 are not activated if the fluid circulation system 220 does not have sufficient water.

In some embodiments, a soil moisture sensor 280 (e.g. an EC-5 type soil moisture sensor) may be provided proximate the roots of the plant 219. In this embodiment, the soil moisture sensor 280 is disposed within the plant-containing vessel 216 as shown in FIG. 6. More specifically, the soil moisture sensor 280 in this example is disposed within the rockwool 306 and may measure the moisture of rockwool 306 around the roots. In other embodiments, the soil moisture sensor 280 may be at any suitable location proximate the roots of the plant 219.

In some embodiments, the fifth pump 249 may be operatively connected to the soil moisture sensor 280 and responsive to output therefrom to control the amount of water being supplied to the drip ring 251. Use of the soil moisture sensor 280 may help to avoid overwatering or underwatering of the plant 219.

In some embodiments, the apparatus 200 may also include a door sensor (not shown), such as a 1568-1607-ND sensor. Leaving the door ajar can cause odour issues, light leakage and interfere with temperature control. The door sensor may, thus, be used for notifications that a door of the apparatus 200 is open. For example, a notification may be output if the door sensor detects that a door has been opened longer than a threshold time and/or if one or more conditions dictate that the door should be closed.

The apparatus 200 in this example includes a central control module 270. Example inputs and control signal outputs of the control module 270 are labelled in FIG. 5. The central control module 270 may be operatively connected to the various monitoring and control components described above. For example, central control module 270 may be operatively connected to one or more of: the water pumps 231, 233, 236, 243, and 249; the solenoid valve 268; the air pump 244; the push button switches (switch1, switch2, switch3, switch4); the pumps 281a to 281d that control output from the first and second nutrient containers 238a and 238b and the first and second pH chemical containers 239 and 240; the TEC modules 254a to 254c; the temperature, humidity, and CO2 tri-sensor 258; the LED module 256 (and dimmers); and/or the TDS/EC and pH probes 262 and 264. The central control module 270 may also be connected to additional environmental monitoring and control mechanisms not specified above.

The central control module 270 may further be operatively connected to one or more user interfaces and/or remote devices for: (1) receiving input for controlling the various monitoring and control components described above; and/or (2) providing output for indicating a status or condition of the apparatus 200 and/or plant(s) 219 contained therein. The central control module 270 may be operatively connected to the user interface and/or remote device through wired and/or wireless communication. The remote device may comprise, for example, a smart phone, tablet, or personal computer.

The central control module 270 may comprise one or more processors and one or more memories storing processor-executable instructions that, when executed, cause the one or more processors to implement the various functionality and control steps described herein.

In this example, the control module 270 comprises two control boards: a main control board 272 and a water quality (WQ) board 276. Each of these boards may comprise one or more processors and memory. In other embodiments, the control module 270 may be organized into more or fewer boards or other functional modules.

The main control board 272 may, for example, comprise a Particle P1TM micro controller (e.g. STM32 microcontroller). The WQ board 276, and associated TDS/EC and pH probes 262 and 264, may comprise an Atlas™ industrial grade pH and EC measurement system, for example. EC and pH probes typically cannot be read directly with a microcontroller. The TDS/EC and pH probes 262 and 264 pick up the signal, and an ADC (analogue to digital conversion) circuit translates that analog signal to digital signal so that the of the main control board 272 can measure it.

In some embodiments, the control module 270 may comprise a wireless communication means, such as a Wi-Fi module. The control module 270 may further include one or more antennas, such as Wi-Fi antenna 278. In some embodiments, the apparatus 200 may have Internet of Things (IoT) capability and may communicate over one or more wireless networks.

The control module 270 may run a real-time operating system (RTOS). The RTOS may be used to control the various functions described herein. The apparatus 200 may also communicate with remote devices and/or the cloud. In some embodiments, the apparatus 200 may be configured to receive Over the Air (OTA) updates (e.g. firmware updates).

In some embodiments, the apparatus 200 may be provided with an identification code or number used to identify the apparatus 200 from other grow box apparatuses or other devices communicating on a network (e.g. IoT network). Controlling software run by the control module 270 may differentiate between apparatuses and load relevant software to give device specific controls.

The control module 270 may include additional hardware or software not specifically described herein. The control module 270 may also be modifiable to add additional hardware and/or software.

In operation, the apparatus 200 may provide various environmental monitoring and control functions, as described above. These functions may be at least partially automated and controlled by the control module 270. The control module 270 may independently and selectively control one or more environmental parameters of the growing zone 208 and/or the root zone 210 as described above.

In some embodiments, the control module 270 may be configured to implement timer-based control options. As an example, timer-controlled light and/or watering schedules may be implemented. As another example, timer-controlled nutrient dosing may also be implemented.

These various functions of the apparatus 200 may be implemented using software, hardware or a combination thereof. As discussed above, the control module 270 may include one or more processors and memories. Various environmental condition parameters (set points) may be predetermined and stored in the one or more memories. For example, set points may be provided for temperature of the growing zone 208 and/or the root zone 210, humidity, CO2 level, soil moisture, pH of the water solution 224, etc.

Various other monitoring and control functionalities may be at least partially automated and controlled by the control module 270 and embodiments are not limited to the specific functionalities described herein.

In some embodiments, the apparatus 200 may include various output means for providing output indicating a status of the apparatus 200. In some embodiments, a front display panel 252 may be provided on the exterior of the apparatus 200, for example on one of the doors. The front display panel 252 may comprise status indicators that display a status of the apparatus 200 based on current settings and/or detected environmental conditions. The front panel 252 may also produce output based on one or more detected plant properties, as described in more detail below.

In some embodiments, a plurality of visual indicators (e.g. RGB LEDs) of the front panel 252 may show various status indications. In this example, the front panel 252 comprises five RGB LEDs 289. However, the output means are not limited to visual indicators and other output means, such as audio output means, are also possible.

In some embodiments, output indicating environmental and/or plant conditions of the apparatus 200 may be output electronically to one or more remote devices (e.g. via wired or wireless connection). In some embodiments, output may be displayed to a user in a mobile application on a remote device, for example, a smart phone or tablet, as described in more detail below.

In some embodiments, the apparatus 200 may comprise one or more input means. For example, in some embodiments, the front panel 252 may also comprise push buttons 290 for device setup and reset. The push buttons 290 may be manipulated by the user to activate or adjust various control functions of the apparatus 200. For example, the user may use the push buttons 290 to initiate watering, reschedule a lighting cycle, adjust the temperature of the growing zone 208 or root zone 210, etc.

In some embodiments, the apparatus 200 may include one or more additional push buttons, for example, for device recovery options. However, input means are not limited to push buttons and other input means such as a touchscreen, keyboard, keypad, trackpad, mouse, microphone for audio input, etc. are also possible.

In some embodiments, the control module 270 of the apparatus 200 may be configured to receive input from a remote device, for example, via a mobile application, as described in more detail below.

Plumbed Mode

In some embodiments, the apparatus 200 of FIG. 5 may be operable in a plumbed mode. As used herein, “plumbed mode” refers to operation of the apparatus 200 when the apparatus 200 is receiving water from a plumbed water source.

An example of operation of the apparatus 200 in the plumbed mode will now be described. A user may activate automated control functions (e.g. a program run by the control module 270) after the plant 219 is secured in the vessel 216. Set points and program parameters may, for example, be loaded from default or saved. The water pump 231 may be activated pump water into the mix reservoir 226 until Float 2 is engaged (e.g. 2 Gallons). Nutrients n1 or n2 may be released as per a fixed schedule. The schedule may be predetermined and stored in the control module 270 and/or set by a user or a remote device. Similarly, pH may be balanced as per a predetermined set point and/or based on input from the user or remote device. Water may be allowed to acclimate for a predetermined time (e.g. half an hour). After the predetermined time, the first water pump 231 may be deactivated, and the second water pump 233 may be activated to fill the plant reservoir 222. The second water pump 233 may pump a determined amount of solution (e.g. 1 Gallon) into the plant reservoir 222. The fifth water pump 249 may then irrigate the plant 219 via the drip ring 251 based on set points of the soil moisture sensor 280.

At a desired time, the third pump 243 may be activated to drain the water solution 224 from the plant reservoir 222 into the mix reservoir 226 and the second water pump 233 may be re-activated to re-fill the plant reservoir 222. This may be done so that pH balanced water is available in the plant reservoir 222 and all mixing happens in the mix reservoir 226. This cycle of draining and refilling the plant reservoir 222 may be repeated on a periodic schedule (e.g. twice a day) and/or as needed.

At a desired time, the third water pump 243 may be activated to drain all of the water solution 224 from the plant reservoir 222 into the mix reservoir 226. The fourth water pump 236 may drain the mix reservoir 226 by pumping the water solution 224 to the outlet 242. The first water pump 231 may then be activated to refill the mix reservoir 226 with fresh water from via inlet 228. Draining and re-filling the water reservoirs 222, 226 from time to time may help to prevent the water solution from settling and may also help to reduce or eliminate bacteria and/or algae growth. This cycle of draining and refiling may be repeated on a periodic schedule (e.g. once per week) and/or as needed.

Standalone Mode

In some embodiments, the apparatus 200 of FIG. 5 may also be operable in a standalone mode. As used herein, “standalone mode” refers to operation of the apparatus 200 when the apparatus 200 is not receiving water from a plumbed water source. For example, the standalone mode may be used when the apparatus 200 is not connected to a plumbed water source and/or if the amount and/or quality of water from the plumbed water source is insufficient.

In the standalone mode, a user may still activate automated control functions (e.g. program run by the control module 270) after the plant 219 is secured in the vessel 216. Set points and program parameters may, for example, be loaded from default or saved. In most ways, the standalone mode may function similarly or the same as the plumbed mode, with the exception that the user will occasionally manually drain the water solution 224 from the circulation system 220 and manually refill the mix reservoir 226.

The user may fill the mix reservoir 226 with a determined amount of water (e.g. with a vessel). The control module 270 may then implement the same steps for: mixing the water with n1, n2, pH+, pH−, etc.; acclimating the water and initially filling the plant reservoir 222; and periodically draining and re-filling of the plant reservoir 222 (e.g. twice a day). These functions may be triggered once Float 2 is engaged by the user filling the mix reservoir 226.

The draining/refilling cycles may continue until Float 1 is reached in the mix reservoir 226. At that point, the fluid circulation system 220 will need to be refilled. The fourth water pump 236 may be activated to drain the mix reservoir 226 (e.g. into a vessel). The user may then refill the mix reservoir 226 with fresh water and the cycle may be repeated.

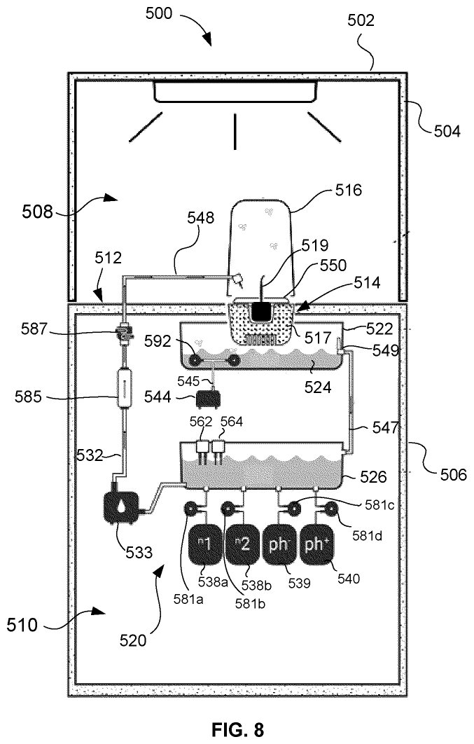

Alternative embodiments of the fluid circulation system will now be described with reference to FIGS. 7 to 9.

FIG. 7 is a schematic view of a plant incubation apparatus 400 with a single-reservoir fluid circulation system 420 according to some embodiments.

The apparatus 400 may comprise a housing 402 with an upper housing portion 404 and a lower housing portion 406. A growing zone 408 may be defined in the upper housing portion 404 and a root zone 410 may be defined in the lower housing portion 406. A partition 412 may segregate the growing zone 408 and the root zone 410.

A plant-retaining opening 414 may extend through the partition 412. A plant-containing vessel 416, having a plant 419 therein, may be received into the opening 414 such that the roots (not shown) of the plant 419 are positioned in the root zone 410 and the remainder of the plant 419 is positioned in the growing zone 408. The plant-containing vessel 416 may be similar to the plant-containing vessel 216 of FIG. 6.

The fluid circulation system 420 in this embodiment comprises a single reservoir 422 containing a water solution 424 therein. The roots (not shown) of the plant 419 may at least be partially suspended in the water solution 424 in the reservoir 422.

Water may be manually added to the reservoir 422 using a removable water vessel 423. First and second nutrient containers 438a and 438b (storing nutrients n1 and n2) and first and second chemical containers 439 and 440 (storing pH controlling chemicals pH− and pH+) may be fluidly connected to the reservoir 422 via pumps 481a, 481b, 481c, and 481d, respectively. Therefore, in this embodiment, the water, nutrients n1 and n2, and pH chemicals pH− and pH+ may mix together in the reservoir 422 to form the water solution 424. A TDS/EC probe 462 and a pH probe 464 may be provided at the reservoir 422, similar to the TDS/EC probe 262 and pH probe 264 of FIG. 5. Air may be provided to the reservoir 422 by an air pump 444 via air line 445.

The water solution 424 may flow from the reservoir 422 to a watering line 448 via lines 431, 432, and 434, or the water solution 424 may be drained to an outlet 442 via lines 431, 432, and 435. A water pump 433 may drive the flow of the water solution 424 through lines 432 and 434 or 435. A first valve 436 may be provided on line 434 and a second valve 437 may be provided on line 435. First and second valves 436 and 437 may be solenoid valves, for example. When the first valve 436 is open and the second valve 437 is closed, the water solution 424 may flow from the reservoir 422 to the watering line 448. Alternatively, when it is desired to partially or fully drain the water solution 424 from the fluid circulation system 420, the first valve 436 may be closed and the second valve 437 may be opened such that the water solution 424 drains from the outlet 442.

The watering line 448 may supply the water solution 424 to a watering mechanism 450 such as a drip ring. In some embodiments, a ceramic filter 485 and a UV filter 487 may be provided on watering line 448 to filter the water solution 424 being supplied to the watering mechanism 450.

The apparatus 400 may otherwise operate in a similar manner to the apparatus 200 as described above.

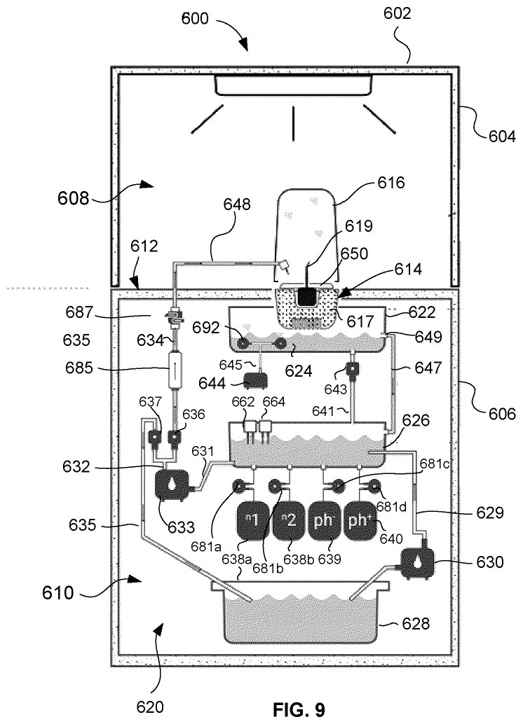

FIG. 8 is a schematic view of a plant incubation apparatus 500 with an alternative two-reservoir fluid circulation system 520 according to some embodiments.

The apparatus 500 may comprise a housing 502 with an upper housing portion 504 and a lower housing portion 506. A growing zone 508 may be defined in the upper housing portion 504 and a root zone 510 may be defined in the lower housing portion 506. A partition 512 may segregate the growing zone 508 and the root zone 510.

A plant-retaining opening 514 may extend through the partition 512. A plant-containing vessel 516, having a plant 519 therein, may be received into the opening 514 such that the roots (not shown) of the plant 519 are positioned in the root zone 510 and the remainder of the plant 519 is positioned in the growing zone 508.

The fluid circulation system 520 in this embodiment comprises a plant reservoir 522 and a mix reservoir 526 containing a water solution 524 therein. The roots (not shown) of the plant 519 may at least be partially suspended in the water solution 524 in the plant reservoir 522. Air may be provided to the plant reservoir 522 by an air pump 544 via air line 545.

Water may be manually added to the mix reservoir 526 using a removable water vessel (not shown). First and second nutrient containers 538a and 538b (storing nutrients n1 and n2) and first and second chemical containers 539 and 540 (storing pH controlling chemicals pH− and pH+) may be fluidly connected to the mix reservoir 526 via pumps 581a, 581b, 581c, and 581d, respectively. A TDS/EC probe 562 and a pH probe 564 may be provided at the mix reservoir 526 to measure the water quality of the water solution 524 therein.

The water solution 524 may flow from the mix reservoir 526 to a watering line 548 via line 532. A water pump 533 may drive the flow of the water solution 524 through line 532 to the watering line 548. The watering line 548 may supply the water solution 524 to a watering mechanism 550 such as a drip ring. In some embodiments, a ceramic filter 585 and a UV filter 587 may be provided on the watering line 548 to filter the water solution 524 being supplied to the watering mechanism 550.

As the watering mechanism 550 supplies the water solution 524 to the plant 519, excess water solution 524 may drain through perforations 517 in the plant-containing vessel 516 into the plant reservoir 522. As the plant reservoir 522 fills with the water solution 524, a valve 549 may be opened to allow the water solution 524 to drain through an overflow line 547 to the mix reservoir 526. The mix reservoir 526 may be manually drained as needed.

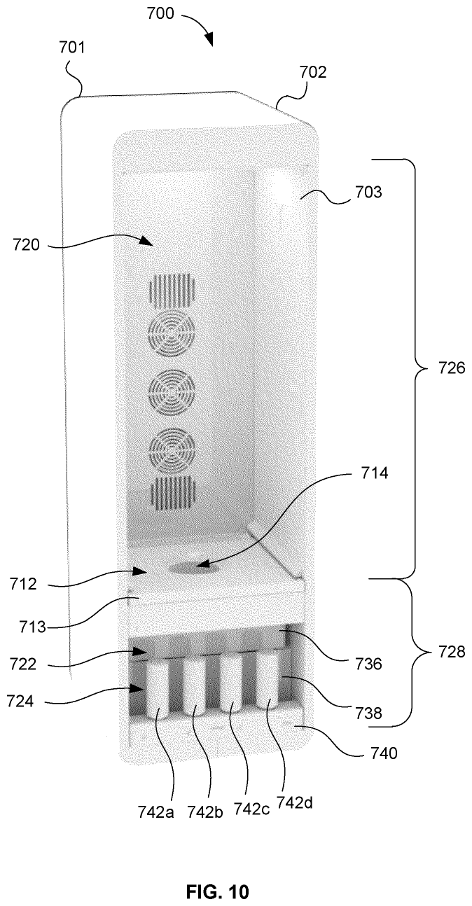

FIG. 9 is a schematic view of a plant incubation apparatus 600 with a three-reservoir fluid circulation system 620 according to some embodiments.

The apparatus 600 may comprise a housing 602 with an upper housing portion 604 and a lower housing portion 606. A growing zone 608 may be defined in the upper housing portion 604 and a root zone 610 may be defined in the lower housing portion 606. A partition 612 may segregate the growing zone 608 and the root zone 610.

A plant-retaining opening 614 may extend through the partition 612. A plant-containing vessel 616, having a plant 619 therein, may be received into the opening 614 such that the roots (not shown) of the plant 619 are positioned in the root zone 610 and the remainder of the plant 619 is positioned in the growing zone 608.

The fluid circulation system 620 in this embodiment comprises a plant reservoir 622, a mix reservoir 626, and a supplementary reservoir 628. The roots (not shown) of the plant 619 may at least be partially suspended in the plant reservoir 622 in a water solution 624. Air may be provided to the plant reservoir 622 by an air pump 644 via air line 645. Air stones 692 may bubble the air into the water solution 624 within the plant reservoir 622.

In this example, the supplementary reservoir 628 may be removable and may be removed from the apparatus 600 to be manually filled with fresh water. When the supplementary reservoir 628 is installed in the apparatus 600, water may flow from the supplementary reservoir 628 to the mix reservoir 626 via line 629. A first water pump 630 may be activated and controlled to drive the flow of the water from the supplementary reservoir 628 to the mix reservoir 626. First and second nutrient containers 638a and 638b (storing nutrients n1 and n2) and first and second chemical containers 639 and 640 (storing pH controlling chemicals pH− and pH+) may be fluidly connected to the mix reservoir 626 via pumps 681a, 681b, 681c, and 681d, respectively. A TDS/EC probe 662 and a pH probe 664 may be provided at the mix reservoir 626 to measure the water quality of the water solution 624 therein.

The mixed water solution 624 may flow from the mix reservoir 626 to a watering line 648 via lines 631, 632, and 634, or the water solution 624 may be drained to the supplementary reservoir 628 via lines 631, 632, and 635. A second water pump 633 may drive the flow of the water solution 624 through lines 632 and 634 or 635. A first valve 636 may be provided on line 634 and a second valve 637 may be provided on 635. First and second valves 636 and 637 may be solenoid valves, for example. When the first valve 636 is open and the second valve 637 is closed, the water solution 624 may flow from the mix reservoir 626 to the watering line 648. Alternatively, when it is desired to partially or fully drain the water solution 624 from the mix reservoir 626, the first valve 636 may be closed and the second valve 637 may be opened such that the water solution 624 drains to the supplementary reservoir 628. The supplementary reservoir 628 may then be removed from the apparatus 600 to be emptied and re-filled with fresh water.

The watering line 648 may supply the water solution 624 to a watering mechanism 650 such as a drip ring. In some embodiments, a ceramic filter 685 and a UV filter 687 may be provided on watering line 648 to filter the water solution 624 being supplied to the watering mechanism 650.

As the watering mechanism 650 supplies the water solution 624 to the plant 619, excess water solution 624 may drain through perforations 617 in the plant-containing vessel 616 into the plant reservoir 622. As the plant reservoir 622 fills with the water solution 624, a valve 649 may be opened to allow the excess water solution 624 to drain through an overflow line 647 to the mix reservoir 626.

When it is desired to partially or fully drain the plant reservoir 622, a valve 643 may be opened to allow the water solution 624 to flow from the plant reservoir 622 to the mix reservoir 626 via a drain line 641. The mix reservoir 626 may then be drained to the supplementary reservoir 628 as described above.

Air Circulation

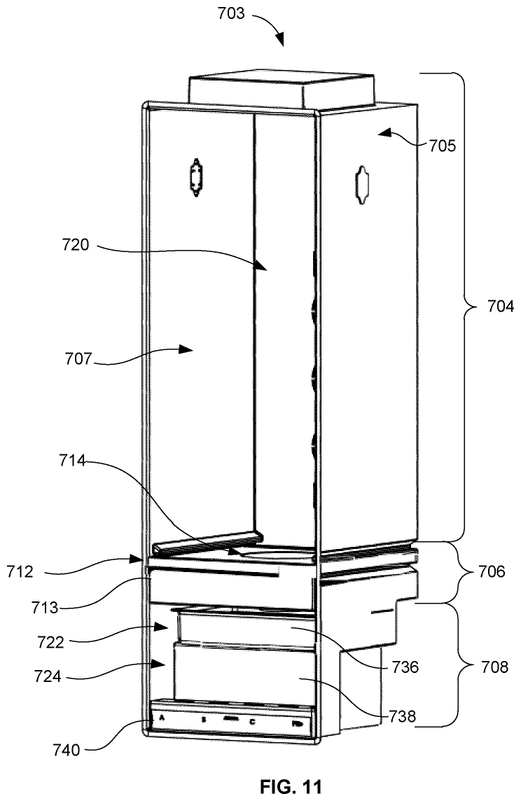

Air circulation and air temperature control within a plant incubation apparatus 700, according to some embodiments, will now be described with reference to FIGS. 10 to FIG. 13E. The apparatus 700 is shown without doors; however, the apparatus 700 may comprise doors similar to the apparatus 100 as described above.

As shown in FIG. 10, the apparatus 700 may comprise a housing 702 including an outer housing 701 with an inner housing 703 therein. The inner housing 703 may define an upper chamber 720 and a lower chamber 722. The upper chamber 720 may generally define a growing zone 726 and the lower chamber 722 may generally define a root zone 728.

A partition 712 may separate the upper chamber 720 from the lower chamber 722. In this embodiment, the partition comprises a panel 713. The panel 713 may have a plant-retaining opening 714 extending therethrough.

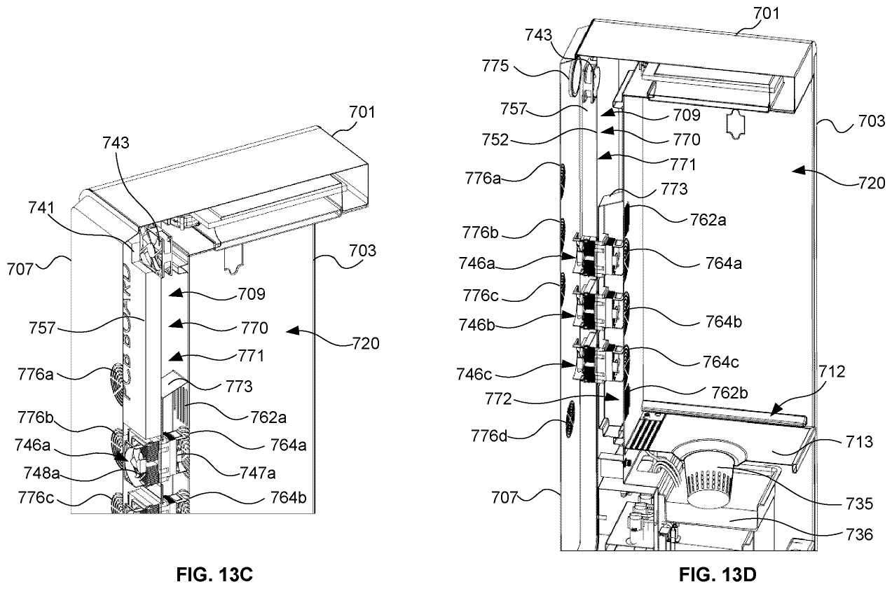

In this example, a reservoir area 724 may be defined within the lower chamber 722 and may have a first reservoir 736 and a second reservoir 738 therein. As shown in FIGS. 13A and 13B, a receptacle 735 (e.g. a basket) may be coupled to the panel 713 below the plant-retaining opening 714 and above the first reservoir 736. A plant (not shown) may be positioned in the receptacle 735 such that the roots are received into the receptacle 735 in the lower chamber 722 and the remainder of the plant extends upward through the plant-retaining opening 714 into the upper chamber 720. In some embodiments, the receptacle 735 is removable and is removably coupled to the panel 713. In other embodiments, the receptacle 735 may be integral with or permanently coupled to the panel 713.

Also in this example, a platform 740 may be provided for chemical containers 742a, 742b, 742c, and 742d, which may contain nutrients and/or pH controlling chemicals therein. The first and second reservoirs 736 and 738 and the chemical containers 742a, 742b, 742c, and 742d may be fluidly connected in a fluid circulation system 721 as shown in FIGS. 13A and 13B. The fluid circulation system 721 may be similar to the fluid circulation system 220 of FIG. 5 as described above.

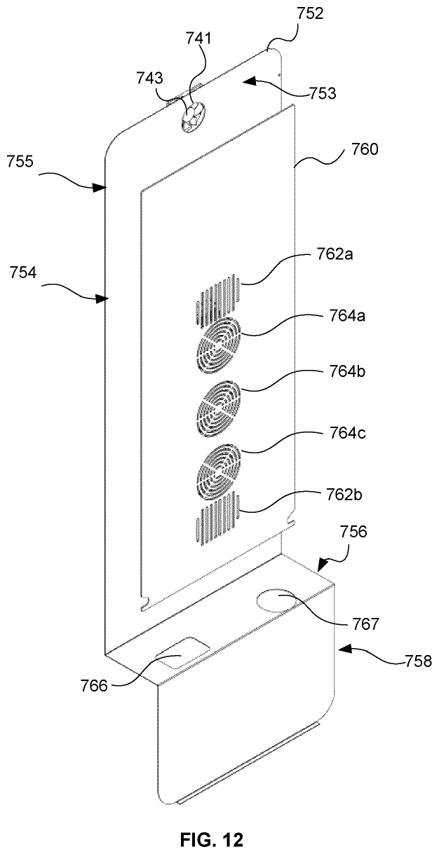

FIG. 11 shows the inner housing 703 removed from the outer housing 701. The inner housing 703 may have an outer face 705 and an inner face 707. The inner housing 703 may have an upper portion 704, a middle portion 706, and a lower portion 708. The upper portion 704 may generally define the upper chamber 720/growing zone 726 and the middle and lower portions 706 and 708 may generally define the lower chamber 722/root zone 722. The partition 712 may be positioned at an upper end of the middle portion 706.

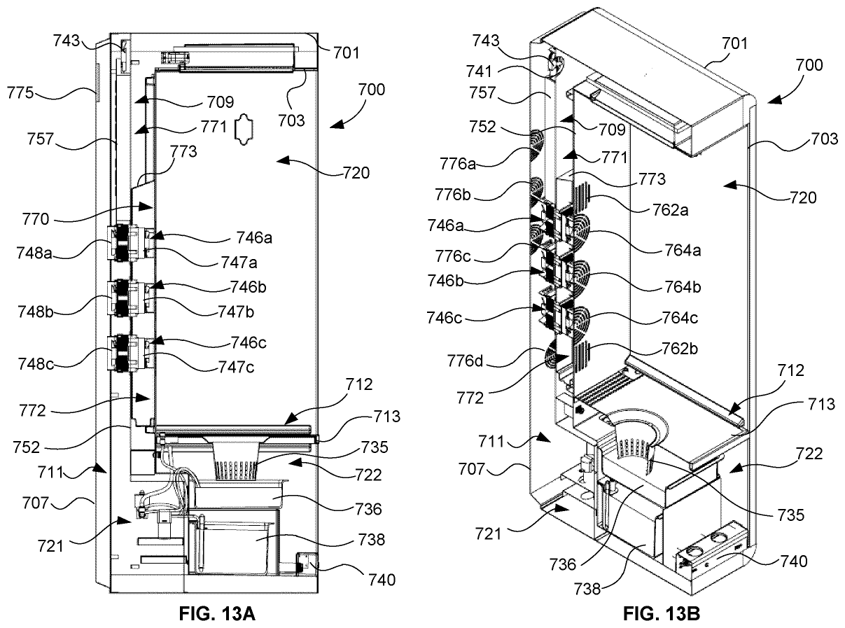

FIG. 12 shows an internal wall 752 that may be disposed between the outer housing 701 and the inner housing 703. The internal wall 752 may be a separate component or may be integral to the outer housing 701 or the inner housing 703. The internal wall 752 may have an inner face 753 and an outer face 755. The internal wall 752 may have an upper portion 754, a lower portion 758, and a middle portion 756 therebetween. The upper and lower portions 754 and 758 may each be substantially vertical and the middle portion 756 may be substantially horizontal. When installed between the inner housing 703 and the outer housing 701 (as shown in FIGS. 13A and 13B), the upper, middle, and lower portions 754, 756, and 758 of the internal wall 752 may be approximately aligned with the upper, middle, and lower portions 704, 706, 708 of the inner housing 703.

In some embodiments, the internal wall 752 may define an aperture 741 therethrough receiving a fan 743 therein. In this embodiment, the aperture 741, with the fan 743 therein, is disposed in the upper portion 754 of internal wall 752.

In some embodiments, additional apertures may be provided in the internal wall 752. For example, apertures 766 and 767 may be provided in the middle portion 756 to receive components of the fluid circulation system 721 as shown in FIGS. 13A and 13B.

As shown in FIGS. 13A and 13B, in some embodiments, at least one TEC module may be positioned on the internal wall 752. In this example, a first, second, and third TEC module 746a, 746b, and 746c are mounted on the upper portion 754 of the internal wall 752. Each of the TEC modules 746a, 746b, and 746c may extend through the internal wall 752 from the inner face 753 to the outer face 755. A control board 757 may be mounted on the outer face 755 and may be operatively connected to the TEC modules 746a, 746b, and 746c. The control board 757 may be similar to the control module 270 of FIG. 5 as described above.

Each TEC module 746a, 746b, and 746c may include a respective intake fan 747a, 747b, and 747c extending from the inner face 753 of the internal wall 752 and a respective exhaust fan 748a, 748b, 748c extending from the outer face 755. In some embodiments, the TEC modules 746a, 746b, and 746c include a heat sink (not shown) and the exhaust fans 748a, 748b, 748c may be attached to the heat sink.

Referring again to FIG. 12, a rear panel 760 of the upper portion 704 of the inner housing 703 is shown. The rear panel 760 may comprise at least one airflow opening therethrough. In this embodiment, the rear panel 760 comprises an upper airflow opening 762a above the TEC modules 746a, 746b, and 746c and a lower airflow opening 762b below the TEC modules 746a, 746b, and 746c. Each airflow opening 762a, 762b may comprise a plurality of slots extending through the rear panel 760.

The rear panel 760 may also comprise at least one ventilation opening for the TEC modules 746a, 746b, and 746c. In this embodiment, the rear panel 760 comprises a first, second, and third ventilation opening 764a, 764b, and 764c for the first, second, and third TEC modules 746a, 746b, and 746c, respectively. Each ventilation opening 764a, 764b, and 764c may comprise a plurality of small apertures extending through the rear panel 760.

FIGS. 13A and 13B show the internal wall 752 and the inner housing 703 (with rear panel 760) installed in the outer housing 701. FIGS. 13C to 13E show enlarged portions of FIGS. 13B.

A rear wall 707 of the outer housing 701 may define a rear airflow opening 775 therethrough that fluidly connects the apparatus 700 with the external environment. The rear airflow opening 775 may be proximate the aperture 741 in the internal wall 752 having the fan 743 installed therein.

The rear wall 707 may also define a plurality of rear ventilation openings therethrough. In this example, a first, second, third, and fourth rear ventilations opening 776a, 776b, 776c, and 776d are defined in the rear wall 707. The first, second, and third rear ventilation openings 776a, 776b, 776c may be disposed proximate the exhaust fans 748a, 748b, 748c of the TEC modules 746a, 746b, and 746c.

The internal wall 752 may be laterally spaced from the inner housing 703 thereby forming an inner medial space 709 therebetween. The internal wall 752 may also be laterally spaced from the outer housing 701, thereby forming an outer medial space 711 therebetween. The outer medial space 711 may be fluidly connected to the external environment via the rear airflow opening 775 and the first, second, third, and fourth rear ventilation openings 776a, 776b, 776c, and 776d. The outer medial space 711 may also partially contain one or more components of the fluid circulation system 721, which may be connected to the first and second reservoirs 736 and 738 via the apertures 766 and 767 in the internal wall 752.

The inner medial space 709 may define a least one air passage 770 therein. In this embodiment, the air passage 770 comprises an upper passage portion 771 and a lower passage portion 772. In some embodiments, the remainder of the inner medial space 709 may be at least partially filled with a filler material such as foam (not shown).

In some embodiments, the upper and lower passage portions 771 and 772 may be separated by a selectively controllable damper 773 therebetween and the damper 773 may be operable to control airflow through the air passage 770. The damper 773 may have an open position (not shown) in which the upper and lower passage portions 771 and 772 are fluidly connected and a closed position (shown in FIGS. 13A to 13E) in which the upper and lower passage portions 771 and 772 are at least partially segregated from one another. In some embodiments, the upper and lower passage portions 771 and 772 may be substantially sealed from one another when the damper 773 is in the closed position.

The airflow openings 762a, 762b and the ventilation openings 764a, 764b, and 764c in the rear panel 760 of the inner housing 703 may fluidly connect the lower passage portion 772 with the upper chamber 720. The TEC modules 746a, 746b, and 746c may be received into the lower air passage 772 such that the intake fans 747a, 747b, and 747c are approximately aligned with the ventilations openings 764a, 764b, and 764c.

As shown in FIG. 13E, the intake fans 747a, 747b, and 747c may be activated to draw air from the upper chamber 720 into the lower passage portion 772 as indicated by arrow B. The air may thereby flow past and contact the TEC modules 746a, 746b, and 746c to be heated or cooled as dictated by the TEC modules 746a, 746b, and 746c. The heated or cooled air may flow back into the upper chamber 720 via the airflow openings 762a, 762b as indicated by arrow C. The air may then circulated in the upper chamber 722 as indicated by arrow D. Excess heat absorbed by the TEC modules 746a, 746b, and 746c may be dispelled from the apparatus 700 by exhaust fans 748a, 748b, 748c via the rear ventilation openings 776a, 776b, and 776c. When air is being circulated through the lower passage portion 772 to be heated or cooled, the damper 773 may be in the closed position.

When it is desired to exhaust air from the upper chamber 720 and/or to provide fresh air into the upper chamber 720, the damper 773 may be moved to the open position and the fan 743 may be activated. With the damper 773 in the open position, air from the upper chamber 720 may flow into the lower passage portion 772 and from the lower passage portion 772 to the upper passage portion 771. The air may then be exhausted to the external environmental by the fan 743 via the aperture 741 and the rear airflow opening 775. Similarly, fresh air may be drawn from the external environment into the upper passage portion 772 via the rear airflow opening 775 and the aperture 741. With the damper 773 in the open position, the fresh air may flow from the upper passage portion 771 to the lower passage portion 772 and from the lower passage portion 772 into the upper chamber 720.

In some embodiments, the damper 773 may be operatively connected to the control board 757 to allow the damper 773 to be automatically controlled. In some embodiments, at least one of a temperature sensor and a humidity sensor (not shown) may be provided to monitor temperature and/or humidity in the upper chamber 720 and the damper 773 may be adjusted between the open and closed position in response to output from the sensor(s).

In some embodiments, at least one TEC module and associated intake/exhaust fans (not shown) may also be operatively connected to the lower chamber 722 for controlling water solution temperature in the fluid circulation system 721. In some embodiments, a cold plate (not shown) may be included into the reservoir area 724 to also help regulate the temperature of the first reservoir 736 and/or second reservoir 738.

Therefore, in some embodiments, the apparatus 700 may provide efficient and evenly distributed temperature control within the growing zone 726 and/or root zone 728. Humidity may also be controlled by exhausting humid air from within the apparatus 700 and bringing in fresh air from the external environment when needed. Complete environmental air distribution may be achieved through a single side of the apparatus (in this example, through the rear of the apparatus 700) which provide flexibility for installation of the apparatus 700 in a variety of settings.

Dual Door System

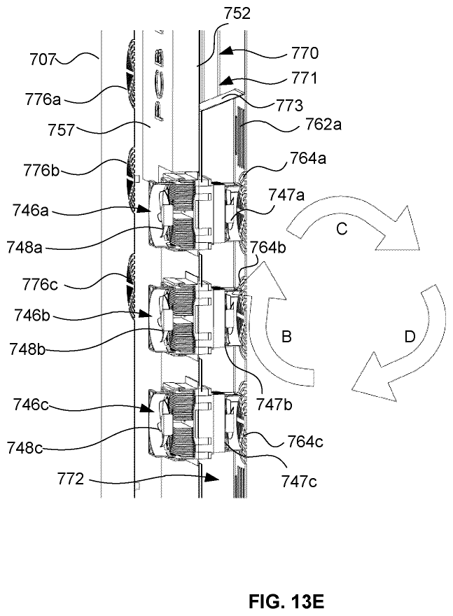

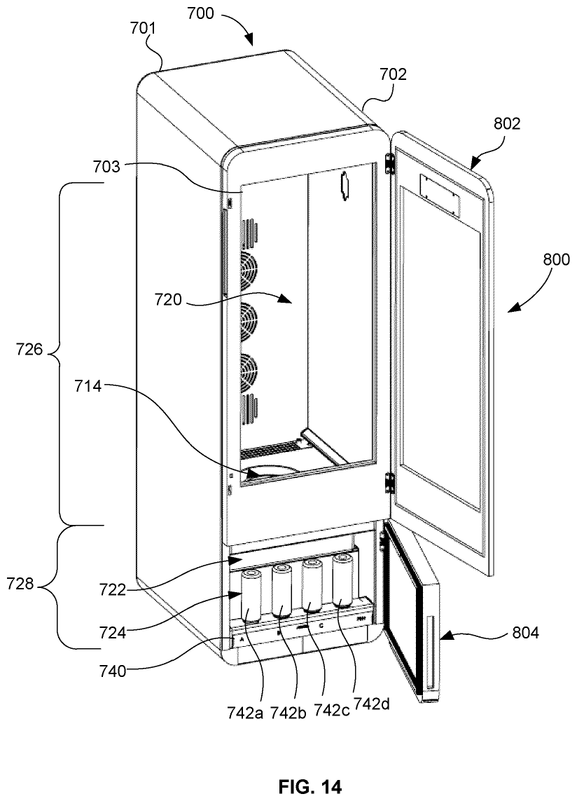

According to some aspects, a dual door system is provided for use with a plant incubation apparatus. An example door system 800 will be discussed with reference to FIGS. 14 to 15C. FIG. 14 shows the door system 800 installed on the apparatus 700 of FIG. 10. The door system 800 may also be used with the apparatuses 100, 200, 400, 500, and 600 as described above.

The door system 800 may include an upper door section 802 and a lower door section 804. The upper and lower doors 802 and 804 may be hingedly attached to the housing 702, for example, by an articulating hinge. The upper door section 802 may provide access to the growing zone 726 and the lower door section 804 may provide access to the root zone 728. This door system 800 may thereby reduce the effects on one zone caused by opening a door to the other zone.

As shown in FIGS. 15A and 15B, the upper door section 802 may include an outer door 806 and an inner door 808. In some embodiments, the outer door 806 may be hingedly attached to the inner door 808, for example, by an articulating hinge. In this embodiment, the outer door 806 is opaque to block light, when closed. The inner door 808 may include a substantially transparent or translucent window 810. The window 810 may allow viewing of the growing zone 726 when the outer door 806 is opened, but the inner door 808 is still closed. In some embodiments, a gasket 811 may be provided on the inner door 808 around the window 810 to allow the inner door 808 to sealingly engage the housing 702 when the inner door 808 is closed.

The window 810 may comprise glass, plastic, or any other suitable transparent or translucent material. In some embodiments, the window 810 may comprise UV-resistant glass to prevent potentially harmful light from penetrating into, or out of, the growing zone 726. As one example, the window 810 may comprise dual pane Low-E (Low Emissivity) module glass. In some embodiments, the window 810 may be shaded to partially restrict light from the outside while still providing a view into the growing zone 726.

Therefore, in some embodiments, plant(s) in the growing zone 726 may be viewed by the user via the window 810 with minimal disturbance to the enclosed environment of the growing zone 726. For example, the inner door 808 may prevent outside air from entering the growing zone 726, which may be cooler and/or less humid than the air of the growing zone 726. The inner door 808 may also prevent potential airborne pollutants and pathogens from entering the enclosed environment of the growing zone 726.

In this example, the lower door section 804 is a unitary body. In other embodiments, the lower door section 804 may include an outer door hingedly attached to an inner door, similar to the outer door 806 and inner door 808 of the upper door section 802. In some embodiments, the lower door section 804 may include a gasket 813 to allow the lower door section 804 to sealingly engage the housing 702 when the lower door section 804 is closed.

In some embodiments, the door system 800 may comprise at least one visual indicator to indicate one or more statuses of the apparatus 700. As shown in FIG. 15C, in this example, a display panel 820 is provided in the upper door portion 802. The display panel 820 may comprise a plurality of LED icons 822. Each LED icon 822 may represent, for example, a status of the apparatus 700, an environmental parameter within the apparatus 700, a property of the plant within the apparatus 700, or any other relevant information. In some embodiments, the color(s) of the individual icons 822 may be used to denote the status of that parameter. For example, red may indicate an alert status, blue may indicate a neutral or acceptable status, and yellow may indicate a warning status.

In some embodiments, another display panel (not shown) may be provided on the lower door portion 804. In some embodiments, the display panel 820 on the upper door portion 802 may be used to indicate at least one status relevant to the growing zone 726 and the display panel on the lower door portion 804 may be used to indicate at least one status relevant to the root zone 728.

In some embodiments, the LED icons 822 may be designed to blend in with the upper door portion 804 until the lighting element (e.g. LED) behind the icon is turned on. Such display elements may be referred to as “secret to lit” icons.

In some embodiments, the door system 800 may comprise at least one control and/or other user interface element. For example, touchscreen(s), button(s), audio outputs/inputs, etc. may also be provided on the upper door portion 802 and/or lower door portion 804. Such features may provide output and/or receive input to control various functionalities of the apparatus 700.

Dynamic Door Warning

According to some aspects, a dynamic door warning system (not shown) for a plant incubation apparatus is provided. The door warning system may be used with the apparatus 700 having the door system 800, for example. However, embodiments are not limited to dual door systems and may be used with any suitable door system. A door warning may be dynamically provided based on one or more environment conditions, such as ambient light, in the environment surrounding the apparatus.

In some embodiments, the apparatus may comprise at least one ambient light sensor to measure ambient light levels in the surrounding environment. The door warning system may be operatively connected to the ambient light sensor and may be responsive to output therefrom. In some embodiments, the door warning system may be operatively connected to the ambient light sensor via a control module. In some embodiments, the door warning system outputs a warning sound. In other embodiments, the door warning system may output any other suitable alert or notification.

In some embodiments, the door warning system may be configured to output the warning sound when the door to the apparatus has been opened for a set period of time. In some embodiments, the set period of time may be dependent on the current lighting level within the apparatus and/or the amount of ambient light in the surrounding environment as measured by the ambient light sensor. As one example, if the door to the apparatus is opened when the internal plant lights are off, the warning sound may be triggered in a shorter time period if the door is opened in a bright environment than if the door is opened in a darker environment.

The apparatus may also sense when the door is opened and make adjustments to the internal lighting level accordingly. For example, if a particular light level is desired in the apparatus, and the door is opened (letting in ambient light), the level of the apparatuses interior light source(s) may be reduced accordingly.

In some embodiments, the apparatus may be configured to show a status indicating whether or not opening a door to the device is currently recommended or acceptable. For example, if outside ambient light is sensed to be higher than a threshold, and depending on internal lighting level, the apparatus may display a status warning indicating that the door should be kept closed.

As another example, the apparatus may comprise a temperature sensor that senses the temperature of the surrounding environment. If the surrounding environment is too cold, the apparatus may display a status warning indicating that only an outer door (in the case of a dual door system) should be opened and the inner door with a viewing window should be kept closed. Other variations are also possible.

Method for Growing a Plant in a Plant Incubation Apparatus

According to some aspects, a method is provided for growing at least one plant in a plant incubation apparatus. The method may be implemented using any of the apparatuses 100, 200, 400, 500, 600, or 700 as described herein.

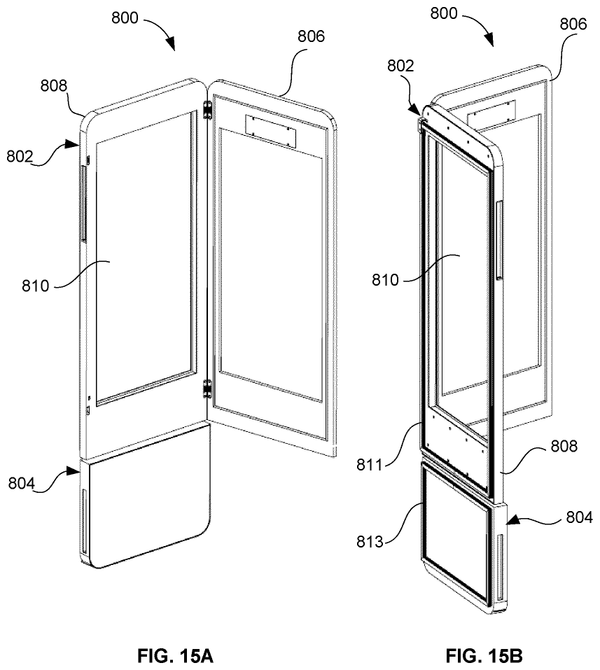

FIG. 16 is a flowchart of an example method 900 for growing at least one plant in a plant incubation apparatus according to some embodiments. At block 902, at least one plant is introduced into the plant incubation apparatus such that the roots of the plant(s) are positioned in a lower chamber and the remainder of the plant(s) are positioned in an upper chamber. The upper and lower chamber may be similar to the upper and lower chamber 120/122 of the apparatus 100, the upper and lower chamber 209/211 of the apparatus 200, or the upper and lower chamber 720/722 of the apparatus 700, for example. In some embodiments, the upper and lower chambers may be separated by a partition having a plant-retaining opening therethrough and the plant may be positioned in the plant-retaining opening. In some embodiments, the plant may be positioned in a plant-containing vessel and the plant-containing vessel may be positioned in the plant-retaining opening. In some embodiments, the roots of the plant are positioned in the lower chamber such that the roots are at least partially suspended in a fluid reservoir containing a water solution suitable for supporting growth of the plant.

At block 904, the at least one plant is incubated in the plant incubation apparatus. The plant may be incubated under environmental conditions suitable for the growth of the plant. For example, the environmental conditions may be selected based on the genus, species, and/or strain of plant and/or based on a desired growth characteristic such as growth rate, flowering time, resin production, etc.

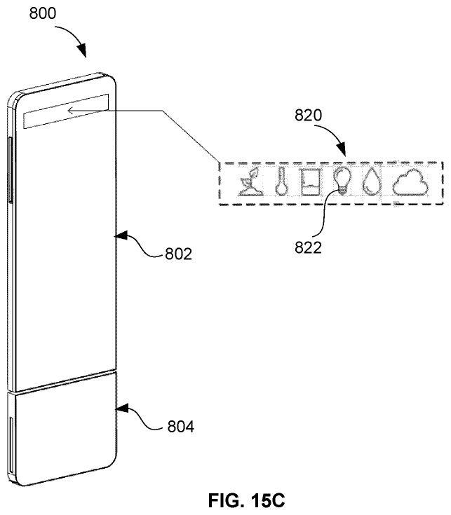

FIG. 17 is a flowchart of another example method 1000 for growing at least one plant in a plant incubation apparatus. The steps at block 1002 and 1004 may be similar to the steps at block 902 and 904 as described above for the method 900. Briefly, at block 1002, at least one plant is introduced into the plant incubation apparatus such that the roots of the plant(s) are positioned in a lower chamber and the remainder of the plant(s) are positioned in an upper chamber. At block 1004, the plant(s) are incubated in the plant incubation apparatus.

At block 1006, an environmental parameter of one of the upper chamber and lower chamber is adjusted independently of the other one of the upper and lower chamber. In some embodiments, the environmental parameter may comprise at least one of: temperature, humidity, CO2 level, light intensity, light spectrum, etc. In other embodiments, the environmental parameter may comprise any other suitable environmental parameter.

In some embodiments, where the roots of the plant are being fed with a water solution, the method 1000 may further comprise adjusting at least one parameter of the water solution feeding the roots of the plant. The at least one parameter of the water solution may comprise, for example, pH, nutrient content, water temperature, water level, etc.

In some embodiments, the method 1000 may further comprise monitoring at least one environmental parameter of the upper and/or lower chamber. In some embodiments, the environmental parameter comprises at least one of temperature, humidity, CO2 level, light intensity, light spectrum, etc. In some embodiments, the step of adjusting at least one environmental parameter at block 1006 is based on feedback from monitoring at least one environmental parameter.

In some embodiments, where the roots of the plant are being fed with a water solution, at least one parameter of the water solution may be monitored. The at least one parameter of the water solution may comprise, for example, pH, electrical conductivity, total dissolved solids, temperature, and water level of the water solution. In some embodiments, the step of adjusting at least one parameter of the water solution is based on feedback from monitoring at least one parameter.

Smart Diagnostics

According to some aspects, a plant incubation apparatus is provided comprising at least one sensing device that collects data indicative of at least one plant property and/or at least one environmental parameter of the apparatus. As used herein, a “plant property” or “property of a plant” may refer to a physical characteristic of the plant and/or a trend in a physical characteristic of the plant. Non-limiting examples of plant properties include size, color, presence of one or more physical blemishes, hot and cold zones, presence and number of flowers, resin production, growth rate and other growth trends, etc.

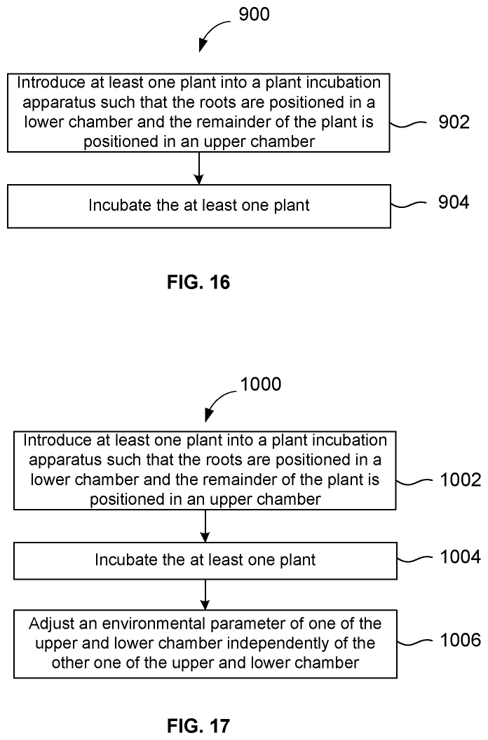

FIG. 18 shows a block diagram of an example plant incubation apparatus 1100 according to some embodiments. The apparatus 1100 may comprise a housing 1102 defining at least one inner chamber 1104 therein. In some embodiments, the at least one inner chamber 1104 may comprise an upper chamber and a lower chamber, similar to the apparatuses 100, 200, and 700 as described above, although embodiments are not limited to the particular structures of the apparatuses described above. At least one plant (not shown) may be positioned in the inner chamber 1104.

The apparatus 1100 may comprise at least one sensing device 1106 operatively connected to the inner chamber 1104. In this example, the sensing device 1106 is disposed within the inner chamber 1104. In other embodiments, the sensing device 1106 may be disposed external to the inner chamber 1104 but may still be operatively connected to the inner chamber 1104 such that the sensing device 1106 can collect data about at least one property of the plant therein and/or at least one environmental parameter of the apparatus 1100.

In some embodiments, where the at least on inner chamber 1104 comprises an upper chamber and a lower chamber, at least one sensing device 1106 may be operatively connected to the upper chamber and at least one sensing device 1106 may be operatively connected to the lower chamber.

In this embodiment, the apparatus 1100 may further comprise a light source 1108, a temperature control 1110, and a fluid circulation system 1112 operatively connected to the inner chamber 1104. Although these features are shown within the inner chamber 1104 it will be understood that some or all of the components of these features may be located external to the inner chamber 1104. In some embodiments, the light source 1108, temperature control 1110, and fluid circulation system 1112 may be similar to the light source 255, the temperature control 253, and the fluid circulation system 220 of the apparatus 200 of FIG. 5, respectively. Other embodiments may omit one or more of the light source 1108, temperature control 1110, and fluid circulation system 1112.

The apparatus 1100 may further comprise at least one processor 1114, a memory 1116, a transceiver 1118, and a user interface 1120. In some embodiments, these components may be incorporated into a control module similar to the control module 270 of apparatus 200 as described above.

The memory 1116 may store processor-executable instructions that, when executed, cause the processor 1114 to perform functions described herein.

The transceiver 1118 may be configured to send and receive communications over a communication network such as the Internet. The communication network may be a wired or wireless network. In some embodiments, the transceiver 1118 comprises both a transmitter and receiver sharing common circuitry. In other embodiments, the transceiver 1118 comprises a separate transmitter and receiver.

The user interface 1120 may be configured to display information to a user and/or to receive user input. In some embodiments, the user interface 1120 may comprise at least one output component and at least one input component. The output component may comprise, for example, one or more lights, a display screen, a display panel, an audio output device, etc. In some embodiments, the display panel may be similar to the display panel 252 of FIG. 5 or the display panel 820 of FIG. 15C as described above. The input component may comprise, for example, one or more buttons, a touchscreen, a keyboard, a keypad, trackpad, mouse, microphone, etc. In some embodiments, the user interface 1120 may be configured to display output and/or receive input from a remote device, as described in more detail below.

In some embodiments, at least one sensing device 1106 may comprise an imaging device such as a camera. The camera may be configured to collect one or images of the plant in the inner chamber 1104. The camera may operate in the visible and/or infrared ranges, for example. In some embodiments, the camera may be configured to collect multiple images of the plant under a predetermined set of parameters. For example, the camera may be configured to collect images at a specific time of day, at a specific light level within the apparatus 1100, etc.

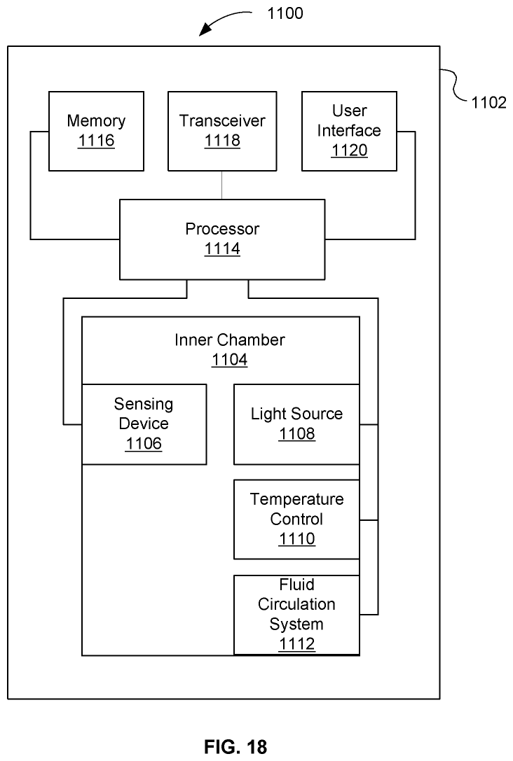

The camera may be configured to collect images of all or part of the plant. FIG. 19 shows an example camera 1200 that may be used as the sensing device 1106 in the apparatus 1100 of FIG. 18. The camera 1200 is shown proximate a leaf 1202 of a plant that may be received into the inner chamber 1104. Example end points of leaves (including 1204a and 1204b) are shown within ellipses in FIG. 19. In this embodiment, the camera 1200 is configured to collect images of such end points, which may be used to indicate size and/or growth properties of the plant. In other embodiments, the camera 1200 may collect images of any other part of the plant.

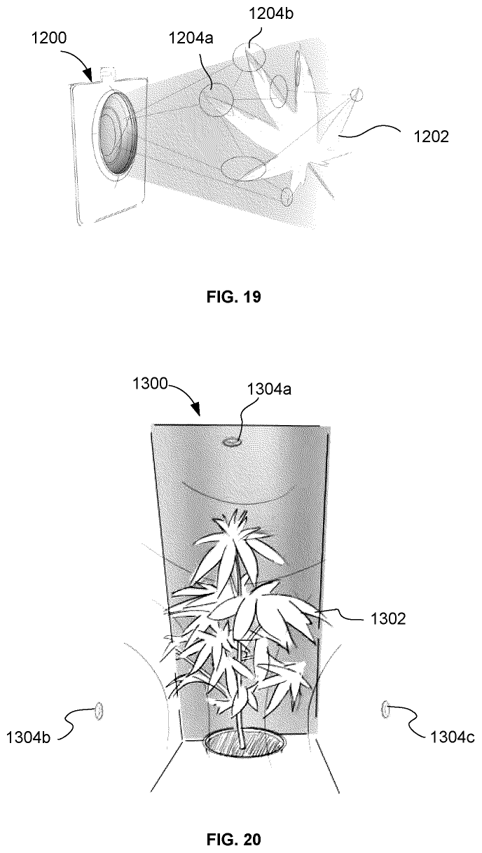

In some embodiments, at least one sensing device 1106 may comprise at least one proximity sensor. FIG. 20 shows a partial interior view of an inner chamber 1300 of an apparatus (similar to the inner chamber 1104 of the apparatus 1100) having proximity sensors 1304a, 1304b, and 1304c installed therein. The proximity sensors 1304a, 1304b, and 1304c may measure the proximity of a plant 1302 thereto, which may be used to indicate size and/or growth properties of the plant. In other embodiments, any suitable number and arrangement of proximity sensors may be provided.

In some embodiments, at least one sensing device 1106 may comprise a weigh scale to measure the weight of the plant.

In some embodiments, at least one sensing device 1106 may comprise a sensing device configured to collect data indicative of one or more environmental parameters within the apparatus 1100. Non-limiting examples of such sensing devices include temperature sensors, humidity sensors, CO2 sensors, moisture sensors, and light sensors, as well as TDS/EC probes, pH probes, and water level sensors for collecting data regarding the water solution being fed to the plant.

In some embodiments, at least one sensing device 1106 may comprise a sensing device configured to collect data indicative of the “health” of the water solution being fed to the plant. For example, such sensing devices may include a sensor for detecting bacteria, a camera system to detect water clarity and level of contamination, a flow rate sensor, or any combination of these or other sensors.

In other embodiments, the apparatus 1100 may comprise any other suitable sensing devices, or combination of sensing devices, and embodiments are not limited to the specific devices described herein.

The processor 1114 may be operatively connected to the sensing device(s) 1106 and may be configured to receive and process data therefrom. In some embodiments, the processor 1114 may process the data to identify one or more plant properties. For example, the processor 1114 may be configured to run image processing software that may process the images from the camera to identify one or more plant properties. In some embodiments, data regarding one or more plant properties may be collected over time.

In some embodiments, the data may be stored in a database. In some embodiments, the database is located on a remote server and the processor 1114 is in communication with the remote server via the communication network. In some embodiments, historical data may be logged and stored in the database.

As an example, the data may comprise color images collected by the camera. The images may be processed to identify colors and color variations (e.g. patches) of part or all of the plant. In some embodiments, color contrast recognition may be used to identify sores, infections, burns, and other blemishes on the leaves and other parts of the plant.

As another example, infrared data may be collected and used to determine plant hot and cold spots. In some embodiments, changes in hot and cold spots may be determined over time. In some embodiments, infrared data may be combined with moisture sensor readings to provide indications of canopy, stalk, and/or quality metrics.

As another example, during flowering, data collected by the camera may be used to determine resin production and flowering in various parts of the plant.

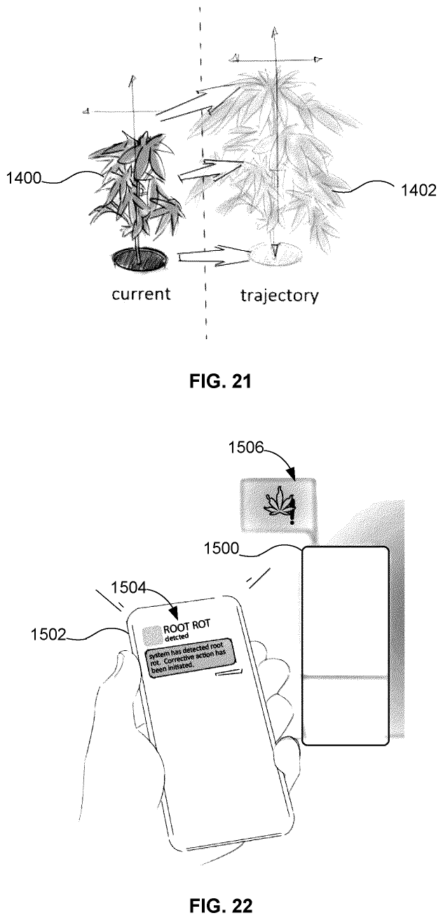

As yet another example, proximity data from the proximity sensors may be used to determine current plant size. The proximity data may be logged over time and may be used to predict a growth trajectory. FIG. 21 illustrates an example plant 1400 with a current size, and an illustrated predicted growth trajectory 1402. Expected growth trajectories (such as expected size data or graphical representations) may be provided or presented to the user.

In some embodiments, various other growth properties of the plant may be tracked over time. Such growth properties may include, but are not limited to: growth rates, canopy spread, plant growth directions and height. Such growth properties may be determined using the proximity data and/or by visual tracking via images obtained by the camera.

In some embodiments, environmental data indicating at least one environmental parameter within the apparatus 1110 may also be collected over time, for example, temperature, humidity, moisture, light level, CO2 level, water quality, water level, etc. In some embodiments, data regarding a water level in a fluid reservoir feeding the roots of the plant may also be used to indicate water consumption by the plant. In some embodiments, at least one plant property and at least one environmental parameter may be logged and compared over time. For example, temperature over time may be compared to the growth rate of the plant to determine the effect of temperature on growth rate and, potentially, to identify an optimal growing temperature.

In some embodiments, where the at least one inner chamber 1104 comprises an upper chamber and a lower chamber, independent data may be collected for each chamber for one or more plant property and/or environmental parameter. For example, at least one sensing device 1106 in the lower chamber may collect data regarding the plant roots (and/or the lower chamber environment) and at least one sensing device 1106 in the upper chamber may collect data regarding the remainder of the plant (and/or the upper chamber environment).

In some embodiments, the data collected about at least one property of the plant and/or at least one environmental parameter of the apparatus 1100 may be used to select and/or adjust at least one operational setting of the apparatus 1100. In some embodiments, at least one operational setting may be adjusted to influence and/or change at least one plant property.

As one example, if an optimal growing temperature is determined as mentioned above, the temperature control 1110 may be set to that temperature to maintain a desired growth rate of the plant. As another example, adaptive lighting may be implemented by adjusting the operational settings of the light source 1108 to an appropriate lighting intensity and/or spectrum for the needs of the plant. Similarly, settings for the fluid circulation system 1112 (e.g. watering levels, water solution composition, etc.) may also be adjusted as appropriate.

In some embodiments, historical data regarding a first plant grown under a first set of growing conditions may be used to select and/or optimize a second set of growing conditions for a second plant. The second plant may be of the same or similar species, strain, etc.

In some embodiments, the apparatus 1100 may automatically adjust at least one operational setting based on data collected via the sensing device(s) 1106 and processed by the processor 1114. In this example, the processor 1114 is operatively connected to at least one of the light source 1108, the temperature control 1110, or the fluid circulation system 1112 and may adjust one or more settings of such systems based on one or more determined plant property and/or environmental parameter. In other embodiments, a user may manually adjust one or more operational settings as desired.

In some embodiments, the processor 1114 may process the data collected via the sensing device(s) 1106 to diagnose one or more plant conditions. As used herein, a “plant condition” may refer to an indication of a problem or undesirable state of the plant. For example, the plant condition may be one or more of: root rot; infection; disease; leaf burning; failure to thrive; low growth rates; delayed flowering; etc. As used herein, “diagnose” may refer to determining if a plant has a plant condition or is likely to have a plant condition, for example, if the plant has one or more plant properties are associated with a given plant condition. In some embodiments, the plant may be diagnosed with the plant condition if one or more plant properties are above or below a predetermined threshold.

In some embodiments, if a plant condition is diagnosed, the apparatus 1100 may automatically initiate one or more corrective actions. In some embodiments, the corrective action may comprise adjusting one or more operational settings of the apparatus 1100 such as, for example, adjusting one or more operational settings of the light source 1108, the temperature control 1110, and/or the fluid circulation system 1112. For example, if a plant is diagnosed with a plant condition, one or more of lighting intensity, light spectrum, temperature, watering amount, nutrient content and/or pH of a water solution, etc. may be adjusted to help remediate the plant.

Alternatively or additionally, if a plant condition is diagnosed, the apparatus 1100 may output one or more alerts via the user interface 1120. In some embodiments, the alert may indicate the plant condition and/or a recommended corrective action.

As one example, if the plant condition diagnosed is root rot, the corrective action may comprise initiating a “stress” mode. The “stress” mode may include shutting off the lights of the light source 1108 and alerting the user via the user interface 1120 to avoid opening the door(s) to the apparatus 1100 to reduce and/or minimizing excessive environmental influence on the plant. For example, a visual warning may be displayed on a display panel indicating that the door to the device should not be opened. The alert may specify a specific period of time and/or the user may be notified by another alert when further collected data (e.g. from the camera) determines that the plant is deemed healthy and ready to return to its normal growth mode. The stress mode may therefore be used to remediate the plant before the stress reaches a crucial point that causes the plant to die or stunts its maturity.

A plant incubation system may include the apparatus 1100 alone, or the apparatus 1100 in communication with one or more remote devices via the communication network. For example, the apparatus 1100 may collect data using the sensing device(s) 1106 and transmit the data to a remote device (e.g. client computer or server) for processing. The remote device may be, for example, a client computer or server. In some embodiments, the remote device may be a mobile communications device such as a smart phone or tablet. In some embodiments, the apparatus 1100 may generate output to the remote device to provide a status indication and/or recommendation to a user.

In some embodiments, the apparatus 1100 may receive one or more control signals from the remote device to adjust one or more operational setting as described above. In some embodiments, the remote device automatically transmits the control signals as a function of the processed data. In other embodiments, control signals may be transmitted to the apparatus 1100 to adjust one or more operational settings based on user input into the remote device.

In other embodiments, once alerted to a plant condition, the user may manually take one or more corrective actions as required. For example, the user may remove a diseased plant from the apparatus 1100 to prevent the infection from spreading to other plants.

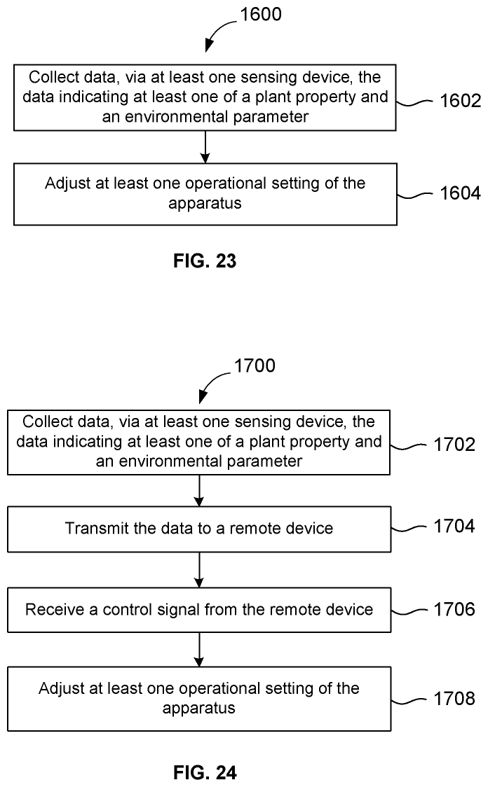

FIG. 22 illustrates an example method of alerting a user of a diagnosed plant condition via a remote device. In FIG. 22, an apparatus 1500 (similar to the apparatus 1100) has determined that a plant therein may have root rot. An alert notification is sent to the user's mobile communications device 1502 (e.g. via a wireless network). A visual notification 1504 is then displayed on the device 1502. The notification 1504 may include an indication of the condition and/or one or more corrective actions. FIG. 22 also shows an enlarged view of an example alert 1506 that may be displayed on a user interface (not shown) of the apparatus 1500.

Therefore, in some embodiments, the apparatus 1100 may function as an intelligent and dynamic monitoring system. In some embodiments, the apparatus 1100 may also function as an at least partially automated treatment system.

Method at a Plant Incubation Apparatus

According to some aspects, a method at a plant incubation apparatus comprising at least one sensing device is provided.

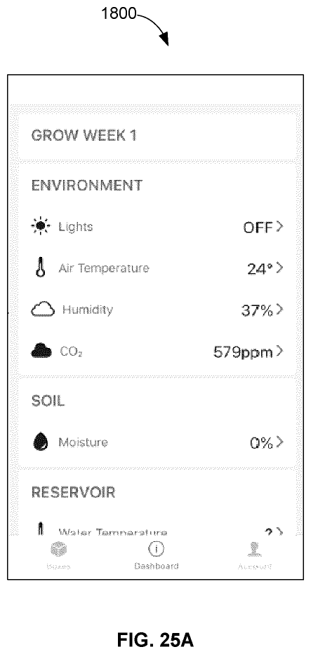

FIG. 23 is a flowchart of an example method 1600. The method 1600 will be described with reference to the plant incubation apparatus 1100 having at least one sensing device 1106 as described above; however, it will be understood that the method 1600 may be implemented using any other suitable plant incubation apparatus.

At block 1602, data is collected via the at least one sensing device 1106, the data indicating at least one of a plant property and an environmental parameter. The sensing device 1106 may comprise any of the sensing devices described above with respect to the apparatus 1100. The collected data may comprise, for example, at least one of: an image, including a color image, infrared image, etc.; proximity data; weight data; environmental data including temperature data; humidity data; CO2 data; moisture data; light intensity and/or spectrum data; total dissolved solids data; electrical conductivity data; pH data; water level data; water health data including bacterial content data, water clarity and/or contamination data; flow rate data; and any other relevant data.

In some embodiments, the collected data may indicate one or more properties of all or part of at least one plant. In some embodiments, the collected data may be processed to indicate one or more of the plant properties. Plant properties that may be indicated by the collected (and processed) data include, for example, at least one of: plant color and color variations; sores, infections, burns, and other blemishes; hot and cold spots; canopy, stalk, and quality metrics; flowering metrics; resin production; current and projected plant size; growth properties including growth rate, canopy spread, plant growth direction and height; and any other relevant plant property. In some embodiments, a first plant property may be indicated for an upper portion of the plant (e.g. stem, leaves, etc.) and a second plant property may be indicated for a lower portion of the plant (e.g. the roots).

In some embodiments, the collected data may indicate one or more environmental parameter within part or all of the apparatus 1100. In some embodiments, the collected data may be processed to indicate one or more of the environmental parameters. Environmental parameters that may be indicated by the collected (and processed) data include, for example, at least one of: temperature; humidity; CO2 level; moisture level; light intensity and/or spectrum; total dissolved solids; electrical conductivity; pH; water level; water health including bacterial content data, water clarity and/or contamination; flow rate; and any other relevant parameters. In some embodiments, where the apparatus 1100 comprises an upper chamber and a lower chamber, an independent environmental parameter may be indicated for each chamber.

In some embodiments, where the apparatus 1100 comprises an upper chamber and a lower chamber, at least one plant property may be indicated for an upper portion of the plant and at least one plant property may be indicated for a lower portion of the plant. In some embodiments, at least one environmental parameter may be indicated for the upper chamber and at least one environmental parameter may be indicated for the lower chamber.

In some embodiments, the collected data may be processed to diagnose at least one plant condition. For example, the plant condition may be one or more of: root rot; infection; disease; leaf burning; failure to thrive; low growth rates; delayed flowering; etc.

At block 1604, at least one operational setting of the plant incubation apparatus is adjusted as a function of the data. The operational setting may comprise, for example, at least one setting for: temperature; humidity; CO2 level; watering amount; light intensity and/or spectrum; nutrient content and/or pH of a water solution feeding the plant; and any other suitable operational setting. In other embodiments, adjusting the operational setting may comprise flushing the fluid circulation system 1112 and refilling the fluid circulation system 1112 with fresh water, for example, if data regarding the water solution indicates that the water quality is low.

In some embodiments, the operational setting is adjusted automatically by the apparatus 1100. In other embodiments, a notification may be generated and displayed to a user via the user interface 1120. The notification may indicate at least one of a plant property, an environmental parameter, and a diagnosed plant condition. In some embodiments, the notification may further include a recommendation. For example, the recommendation may indicate which operational setting to adjust and what type of adjustment is recommended based on the collected data. The user interface 1120 may then receive input from the user to adjust one or more operational settings.

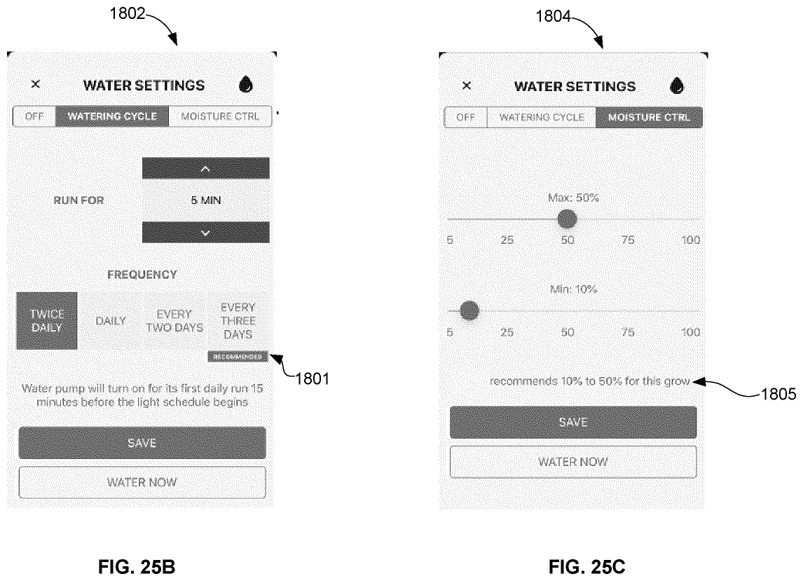

FIG. 24 is a flowchart of another example method 1700 that may be implemented by the apparatus 1100, wherein the apparatus 1100 is in communication with a remote device via a communication network. In some embodiments, the remote device is a mobile communication device such as a smart phone or tablet. In some embodiments, a mobile application is installed on the remote device for communication with the apparatus 1100.

At block 1702, data is collected via the at least one sensing device 1106, the data indicating at least one of a plant property and an environmental parameter. The steps at block 1702 may be similar to the steps at block 1602, as described above.

At block 1704, the data is transmitted to the remote device via the communication network. In some embodiments, the data is processed by the processor 1114 prior to being transmitted to the remote device. In other embodiments, raw data is transmitted to the remote device and the raw data is processed by the remote device to indicate at least one plant property and/or environmental parameter. In some embodiments, processing the data comprises diagnosing at least one plant condition.

In some embodiments, the data transmitted to the remote device may include a recommendation for adjusting at least one operational setting of the apparatus 1100. In other embodiments, the remote device may process the data to generate a recommendation.

At block 1706, a control signal is received from the remote device via the communication network, the control signal indicating at least one operational setting adjustment. In some embodiments, the remote device automatically generates the control signal based on the processed data. In other embodiments, the remote device may receive user input indicating at least one operational setting adjustment and the control signal may be generated based on such user input.

At block 1708, at least one operational setting of the plant incubation apparatus is adjusted in response to the control signal. The steps at block 1708 may be similar to the steps at block 1604 of the method 1600 as described above.

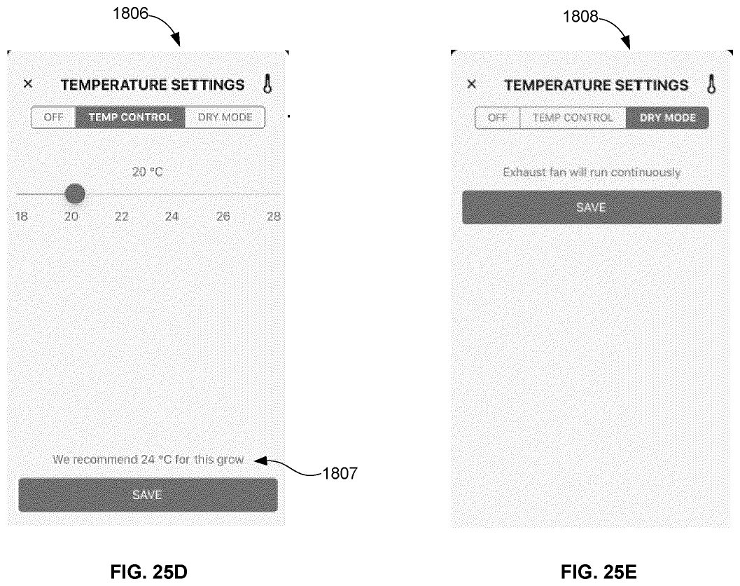

FIGS. 25A to 25H show example screens of a mobile application installed on a remote device (e.g. a smart phone or tablet) that may be used by a user for communication with the apparatus 1100 in the method 1700 as described above. In this example, the apparatus 1100 collects data indicating a variety of environmental parameters.

FIG. 25A shows a homescreen 1800 that displays various environmental parameter indications including lighting level (i.e. the on/off status of the light source), air temperature, humidity, CO2 level, soil moisture, water temperature in the fluid circulation system, etc.

FIG. 25B shows an operational setting screen 1802 for adjusting a watering cycle for a plant within the apparatus 1100. In this example, both watering duration and watering frequency may be adjusted by the user via screen 1802. A recommendation 1803 for watering frequency is also provided on the screen 1812.

FIG. 25C shows an operational setting screen 1804 for adjusting moisture control. A recommendation 1805 for a suitable moisture range is provided on the screen 1804 in this example.

FIG. 25D shows an operational setting screen 1806 for adjusting temperature within the apparatus 1100. A recommendation 1807 for a suitable temperature is provided on the screen 1806 in this example.

FIG. 25E shows an operational setting screen 1808 for adjusting the humidity in the apparatus 1100 by initiating (or ceasing) a “dry mode” in which an exhaust fan runs continuously.

FIG. 25F shows an operational setting screen 1810 for adjusting CO2 level within the apparatus 1100. A recommendation 1811 for a suitable CO2 level (in ppm) is provided on the screen 1810 in this example.

FIG. 25G shows an operational setting screen 1812 for adjusting light settings within the apparatus 1100. In this example, both lighting time and duration may be adjusted by the user via the screen 1812. A recommendation 1813 for lighting duration is also provided on the screen 1812.

FIG. 25H shows an operational setting screen 1814 for adjusting pH of the water solution feeding the plant within the apparatus 1100. A recommendation 1811 fora suitable pH is provided on the screen 1814 in this example.

In some embodiments, one or more screens may be provided indicating one or more plant properties. In some embodiments, one or more plant conditions may be diagnosed and such conditions may also be displayed to the user. In some embodiments, a visual alert notification may be generated and displayed to the user if one or more plant conditions are diagnosed. Other variations are also possible.

Multi-Plant Incubation Apparatus

Embodiments are not limited to a single plant being grown in a plant incubation apparatus. In some embodiments, the apparatus is adapted to incubate a plurality of plants.

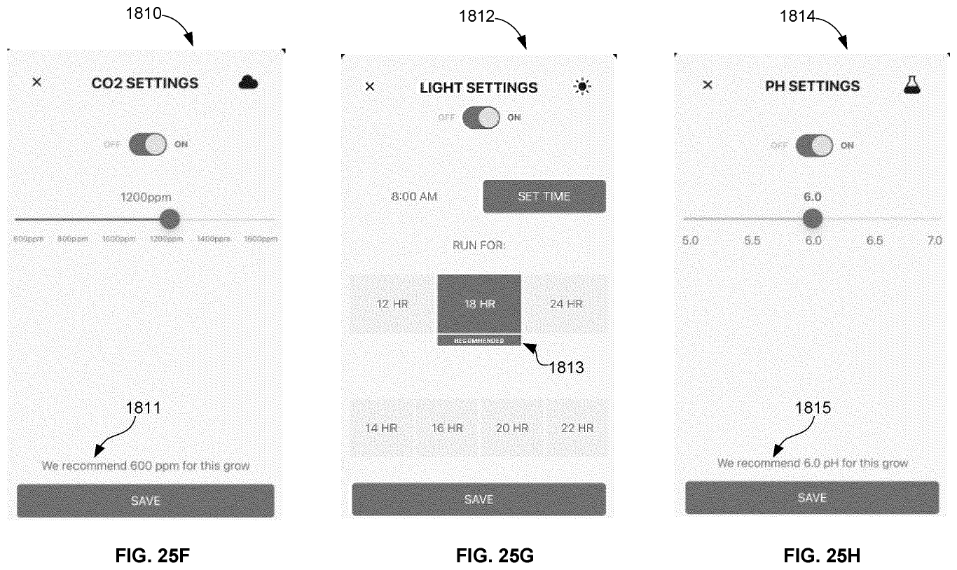

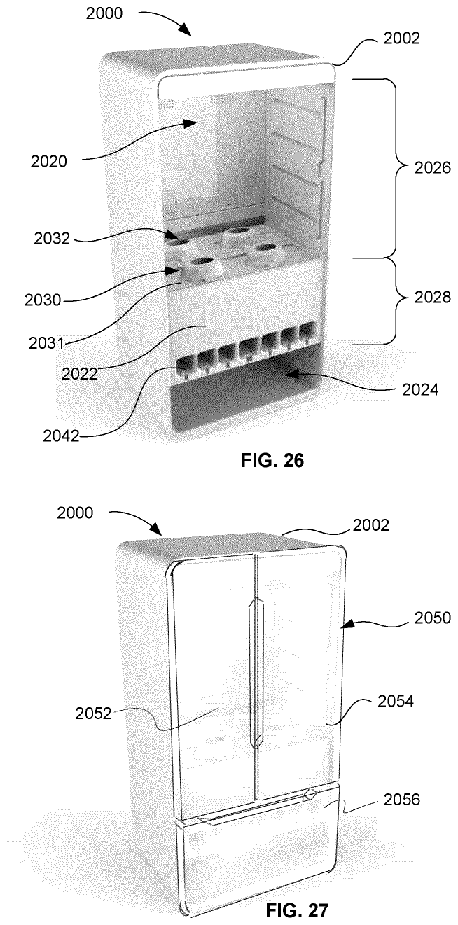

An example of a multi-plant incubation apparatus 2000 will be discussed with reference to FIGS. 26 and 27. In this embodiment, the apparatus 2000 is configured to incubate four individual plants (not shown).

The apparatus 2000 may comprise a housing 2002 defining a growing zone 2026 and a root zone 2028 below from the growing zone 2026. In this example, an upper chamber 2020 generally defines the growing zone 2026 and an inner compartment 2022 generally defines the root zone 2028.

A partition 2030 may at least partially separate the root zone 2028 from the growing zone 2026. In this embodiment the partition 2030 comprises an upper panel 2031 of the inner compartment 2022. In this embodiment, the upper panel 2031 defines four plant-retaining openings 2032 extending from the upper chamber 1020 into the interior of the inner compartment 2022.

In some embodiments, the inner compartment 2022 may contain at least one fluid reservoir therein along with other components of a fluid circulation system (not shown). In some embodiments, a separate fluid reservoir may be provided below each plant-retaining opening 2032 such that the roots of each plant may be suspended in a respective fluid reservoir. In some embodiments, the water solution in each reservoir may be adapted for each individual plant, for example, by adjusting the nutrient content, pH, and/or temperature of the water solution in each reservoir.

In other embodiments, a single reservoir may be provided below all four openings 2032 such that the roots of all four plants are suspended in the same reservoir.

In some embodiments, the inner compartment may 2022 may further comprise a series of bins 2042 for receiving and holding nutrient and/or pH containers therein (not shown). In some embodiments, the inner compartment 2022 may have an access door (not shown) to access the fluid reservoirs and fluid circulation system therein. In some embodiments, a storage chamber 2024 is provided below the inner compartment 2022 where additional equipment and/or supplies may be stored.

The apparatus 2000 may further comprise a door system 2050. In this embodiment, the door system 2050 comprises double-doors 2052 and 2054 for accessing the upper chamber 2020 as well as the inner compartment 2022. A drawer 2056 may be provided to provide access to the storage chamber 2024.

Other variations are also possible. In some embodiments, a plurality of plant containing devices (e.g. planting pods) may be mounted in a single plant incubation apparatus. In some embodiments, each plant may have a designated growing area. A single growing zone (i.e. upper chamber) may contain multiple plant stems, canopies etc. Similarly, a single root zone (i.e. lower chamber) may contain the roots of the multiple plants. In some embodiments, a single apparatus may be physically segregated into multiple adjacent growing zones and root zones, with each pair of growing and root zone being its own closed environment section. In some embodiments, multiple sections may be controlled by a single control module.

Plant Incubation System

According to another aspect, a plant incubation system is provided comprising one or more plant incubation apparatus as described herein. In some embodiments, the apparatuses may be connected to a common control module. In other embodiments, each apparatus has a respective control module. In some embodiments, the apparatuses may be connected to one or more remote devices (e.g. in an IoT network).

It should be apparent to those skilled in the art that more modifications besides those already described are possible without departing from the inventive concepts herein. The inventive subject matter, therefore, is not to be restricted except in the scope of the disclosure. Moreover, in interpreting the disclosure, all terms should be interpreted in the broadest possible manner consistent with the context. In particular, the terms “comprises” and “comprising” should be interpreted as referring to elements, components, or steps in a non-exclusive manner, indicating that the referenced elements, components, or steps may be present, or utilized, or combined with other elements, components, or steps that are not expressly reference.

Although particular embodiments have been shown and described, it will be appreciated by those skilled in the art that various changes and modifications might be made without departing from the scope of the invention. The terms and expressions used in the preceding specification have been used herein as terms of description and not of limitation, and there is no intention in the use of such terms and expressions of excluding equivalents of the features shown and described or portions thereof, it being recognized that the invention is defined and limited only by the claims that follow.

It is to be understood that a combination of more than one of the approaches described above may be implemented. Embodiments are not limited to any particular one or more of the approaches, methods or apparatuses disclosed herein. One skilled in the art will appreciate that variations, alterations of the embodiments described herein may be made in various implementations without departing from the scope of the claims.

1. A plant incubation apparatus, comprising:
a housing defining an upper chamber and a lower chamber, the lower chamber disposed below the upper chamber;
a partition positioned between the upper and lower chambers;
a plant-retaining opening extending through the partition that receives and supports a plant therein such that roots of the plant are positioned in the lower chamber and a remainder of the plant is positioned in the upper chamber.

2. The apparatus of claim 1, wherein the partition substantially environmentally isolates the upper chamber from the lower chamber.

3. The apparatus of claim 1, further comprising at least one first door for accessing the upper chamber and at least one second door for accessing the lower chamber.

4. The apparatus of claim 1, further comprising a first control mechanism operatively connected to the upper chamber and operable to control a first environmental parameter of the upper chamber.

5. The apparatus of claim 4, further comprising a second control mechanism operatively connected to the lower chamber and operable to control a second environmental parameter of the lower chamber.

6. The apparatus of claim 4, wherein the first control mechanism comprises a first temperature control mechanism, the first temperature control mechanism operable to control the temperature of the upper chamber.

7. The apparatus of claim 5, wherein the second control mechanism comprises a second temperature control mechanism, the second control mechanism operable to control the temperature of the lower chamber.

8. The apparatus of claim 4, further comprising at least one sensing device that measures at least one of the first and second environmental parameters.

9. The apparatus of claim 8, further comprising a control module operatively connected to the at least one sensing device and operable to control at least one of the first and second environmental parameters in response to output from the at least one sensing device.

10. The apparatus of claim 1, further comprising a water solution circulation system that supplies a water solution to the roots of the plant.

11. The apparatus of claim 10, wherein the water solution circulation system comprises a first reservoir and a second reservoir, wherein the roots of the plant are at least partially suspended in the first reservoir and the second reservoir supplies the water solution to the first reservoir.

12. The apparatus of claim 11, wherein the second reservoir is in fluid communication with a water source and at least one chemical source such that the water and the at least one chemical are combined in the second reservoir.

13. The apparatus of claim 1, wherein the housing comprises an outer housing and an inner housing, the inner housing defining at least a portion of the upper chamber and lower chamber.

14. The apparatus of claim 13, wherein at least one airflow passage is defined between the outer housing and the inner housing, the airflow passage fluidly connecting at least one of the upper and lower chambers with the external environment.

15. The apparatus of claim 14, further comprising at least one selectively controllable damper positioned in the at least one airflow passage and operable to control airflow through the at least one airflow passage.

16. A method for growing at least one plant in a plant incubation apparatus comprising an upper chamber and a lower chamber, the method comprising:
introducing the at least one plant into the plant incubation apparatus such that roots of the at least one plant are positioned in the lower chamber and a remainder of the at least one plant is positioned in the upper chamber;
incubating the at least one plant in the plant incubation apparatus.

17. The method of claim 16, further comprising adjusting the at least one environmental parameter of one of the upper chamber and the lower chamber independently from the other one of the upper and lower chamber.

18. A plant incubation apparatus comprising:
at least one inner chamber for growing at least one plant;
at least one sensing device operatively connected to the at least one inner chamber, the at least one sensing device collecting data indicative of at least one of a plant property and an environmental parameter within the at least one inner chamber.

19. The apparatus of claim 18, wherein the at least one sensing device comprises a camera, and the data comprises at least one image taken by the camera.

20. The apparatus of claim 18, further comprising at least one processor that processes the data to diagnose a plant condition.

21. The apparatus of claim 20, wherein the at least one processor automatically adjusts at least one operational setting of the apparatus as a function of the data.

22. The apparatus of claim 20, wherein the at least one processor generates output as a function of the data.

23. The apparatus of claim 22, wherein the output is a notification for a user.

24. A method at a plant incubation apparatus comprising at least one sensing device, the method comprising:
collecting data via the at least one sensing device, the data indicating at least one of a plant property and an environmental parameter within the plant incubation apparatus;
adjusting at least one operational setting of the plant incubation apparatus as a function of the data.

25. The method of claim 24, further comprising transmitting the data to a remote device and receiving a control signal from the remote device, the control signal indicating the at least one operational setting to be adjusted.

26. The method of claim 24, wherein the data indicating the at least one plant property is processed to diagnose a plant condition.

27. The method of claim 24, further comprising generating a notification for a user as a function of the data.
